(19) United States
(12) Patent Application Publication
(10) Pub. No.: US 2025/0351134 A1
(43) Pub. Date: Nov. 13, 2025

(54) TECHNIQUES FOR COLLISION HANDLING BETWEEN SEMI-STATIC AND DYNAMIC SCHEDULING

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US)

(21) Appl. No.: 19/092,715

(22) Filed: Mar. 27, 2025

Related U.S. Application Data
(60) Provisional application No. 63/645,038, filed on May 9, 2024.

(51) Int. Cl. H04W 72/1263; H04L 5/14; H04W 72/11

(52) U.S. Cl. CPC H04W 72/1263; H04L 5/14; H04W 72/11

(57) ABSTRACT

Methods, systems, and devices for wireless communications are described. A user equipment (UE) may receive, at a first time, control information that schedules the UE to receive a downlink message or an uplink message that is associated with repetition across one or more full duplex slots. The UE may receive signaling that schedules the UE to transmit one or more uplink messages or one or more downlink messages across the one or more full duplex slots. The UE may determine which of the scheduled messages to communicate, during each full duplex slot based on a respective priority associated with each message and based on whether at least one of the messages overlaps with a transmission timeline relative to the first time.

### CROSS REFERENCES

The present Application for Patent claims benefit of U.S. Provisional Patent Application No. 63/645,038 by ABDELGHAFFAR et al., entitled “TECHNIQUES FOR COLLISION HANDLING BETWEEN SEMI-STATIC AND DYNAMIC SCHEDULING,” filed May 9, 2024, assigned to the assignee hereof, and expressly incorporated herein.

### FIELD OF DISCLOSURE

The following relates to wireless communications, including techniques for collision handling between semi-static and dynamic scheduling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a user equipment (UE) is described. The method may include receiving, at a first time, control information that schedules the UE to receive a downlink message that is associated with repetition across one or more full duplex slots, receiving signaling that schedules the UE to transmit one or more uplink messages across the one or more full duplex slots, where at least one of the one or more uplink messages overlaps in time with at least one repetition of the downlink message, and communicating, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time.

A UE is described. The UE may include one or more memories storing processor executable code, and one or more processors coupled with the one or more memories. The one or more processors may individually or collectively be operable to execute the code to cause the UE to receive, at a first time, control information that schedules the UE to receive a downlink message that is associated with repetition across one or more full duplex slots, receive signaling that schedules the UE to transmit one or more uplink messages across the one or more full duplex slots, where at least one of the one or more uplink messages overlaps in time with at least one repetition of the downlink message, and communicate, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time.

Another UE is described. The UE may include means for receiving, at a first time, control information that schedules the UE to receive a downlink message that is associated with repetition across one or more full duplex slots, means for receiving signaling that schedules the UE to transmit one or more uplink messages across the one or more full duplex slots, where at least one of the one or more uplink messages overlaps in time with at least one repetition of the downlink message, and means for communicating, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time.

A non-transitory computer-readable medium storing code is described. The code may include instructions executable by one or more processors to receive, at a first time, control information that schedules the UE to receive a downlink message that is associated with repetition across one or more full duplex slots, receive signaling that schedules the UE to transmit one or more uplink messages across the one or more full duplex slots, where at least one of the one or more uplink messages overlaps in time with at least one repetition of the downlink message, and communicate, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time.

In some examples of the method, UEs, and non-transitory computer-readable medium described herein, the one or more full duplex slots includes a set of multiple full duplex slots and the method, apparatuses, and non-transitory computer-readable medium may include further operations, features, means, or instructions for receiving, during each full duplex slot of the set of multiple full duplex slots, the repetition of the downlink message based on the respective priority associated with each repetition of the downlink message being greater than the respective priority of each of the one or more uplink messages and dropping, during each full duplex slot of the set of multiple full duplex slots, the one or more uplink messages based on the respective priority associated with each repetition of the downlink message being greater than the respective priority of each of the one or more uplink messages.

In some examples of the method, UEs, and non-transitory computer-readable medium described herein, the one or more full duplex slots includes a set of multiple full duplex slots, the downlink message may be associated with a first subset of repetitions across a first subset of full duplex slots of the set of multiple full duplex slots, the downlink message may be associated with a second subset of repetitions across a second subset of full duplex slots of the set of multiple full duplex slots, and the second subset of full duplex slots may be subsequent to the first subset of full duplex slots.

In some examples of the method, UEs, and non-transitory computer-readable medium described herein, the first subset of repetitions may be associated with a first priority that may be greater than the respective priority of the one or more uplink messages and the method, apparatuses, and non-transitory computer-readable medium may include further operations, features, means, or instructions for receiving, during the first subset of full duplex slots, the first subset of repetitions of the downlink message based on the first subset of repetitions being associated with the first priority.

Some examples of the method, UEs, and non-transitory computer-readable medium described herein may further include operations, features, means, or instructions for transmitting an uplink message of the one or more uplink messages based on the uplink message being scheduled for transmission during a full duplex slot of the second subset of full duplex slots and based on the uplink message being a random access message.

In some examples of the method, UEs, and non-transitory computer-readable medium described herein, the second subset of repetitions may be associated with a first physical layer priority and the method, apparatuses, and non-transitory computer-readable medium may include further operations, features, means, or instructions for transmitting an uplink message of the one or more uplink messages based on the uplink message being scheduled for transmission during a full duplex slot of the second subset of full duplex slots and based on the uplink message being associated with a second physical layer priority that may be greater than the first physical layer priority.

In some examples of the method, UEs, and non-transitory computer-readable medium described herein, the one or more full duplex slots includes a single full duplex slot scheduled with a downlink message via the control information and scheduled with an uplink message via the signaling, a first portion of the uplink message spans a first subset of symbols of the single full duplex slot that may be within the transmission timeline, and a second portion of the uplink message spans a second subset of symbols of the single full duplex slot that may be subsequent to the transmission timeline.

In some examples of the method, UEs, and non-transitory computer-readable medium described herein, the UE may be configured with a cancellation capability to partially cancel messages scheduled for full duplex symbols and the method, apparatuses, and non-transitory computer-readable medium may include further operations, features, means, or instructions for transmitting the first portion of the uplink message and the second portion of the uplink message based on refraining from indicating the cancellation capability to a network entity.

Some examples of the method, UEs, and non-transitory computer-readable medium described herein may further include operations, features, means, or instructions for transmitting, to a network entity, an indication that the UE may be configured with a cancellation capability to partially cancel messages scheduled for full duplex symbols and transmitting the first portion of the uplink message based on the first portion of the uplink message spanning the first subset of symbols within the transmission timeline and based on transmitting the cancellation capability.

In some examples of the method, UEs, and non-transitory computer-readable medium described herein, the UE may be not configured with a cancellation capability to partially cancel messages scheduled for full duplex symbols and the method, apparatuses, and non-transitory computer-readable medium may include further operations, features, means, or instructions for transmitting the first portion of the uplink message and the second portion of the uplink message based on not being configured with the cancellation capability.

Some examples of the method, UEs, and non-transitory computer-readable medium described herein may further include operations, features, means, or instructions for transmitting the first portion of the uplink message based on the first portion of the uplink message spanning the first subset of symbols within the transmission timeline and based on the uplink message being a sounding reference signal (SRS).

In some examples of the method, UEs, and non-transitory computer-readable medium described herein, the control information may be downlink control information (DCI) associated with dynamic scheduling, the signaling may be radio resource control (RRC) signaling associated with semi-static scheduling, the downlink message may be a physical downlink shared channel (PDSCH) or a channel state information reference signal (CSI-RS), and the one or more uplink messages may be one or more of a physical uplink control channel (PUCCH), a physical uplink shared channel (PUSCH), a SRS, or a physical random access channel (PRACH).

A method by a UE is described. The method may include receiving control information that schedules the UE to transmit an uplink message that is associated with repetition across one or more full duplex slots, receiving signaling that schedules the UE to receive one or more downlink messages across the one or more full duplex slots, where at least one of the one or more downlink messages overlaps in time with at least one repetition of the uplink message, and communicating, during each full duplex slot of the one or more full duplex slots, a repetition of the uplink message or a downlink message of the one or more downlink messages based on a respective priority associated with each repetition of the uplink message and each of the one or more downlink messages.

A UE is described. The UE may include one or more memories storing processor executable code, and one or more processors coupled with the one or more memories. The one or more processors may individually or collectively be operable to execute the code to cause the UE to receive control information that schedules the UE to transmit an uplink message that is associated with repetition across one or more full duplex slots, receive signaling that schedules the UE to receive one or more downlink messages across the one or more full duplex slots, where at least one of the one or more downlink messages overlaps in time with at least one repetition of the uplink message, and communicate, during each full duplex slot of the one or more full duplex slots, a repetition of the uplink message or a downlink message of the one or more downlink messages based on a respective priority associated with each repetition of the uplink message and each of the one or more downlink messages.

Another UE is described. The UE may include means for receiving control information that schedules the UE to transmit an uplink message that is associated with repetition across one or more full duplex slots, means for receiving signaling that schedules the UE to receive one or more downlink messages across the one or more full duplex slots, where at least one of the one or more downlink messages overlaps in time with at least one repetition of the uplink message, and means for communicating, during each full duplex slot of the one or more full duplex slots, a repetition of the uplink message or a downlink message of the one or more downlink messages based on a respective priority associated with each repetition of the uplink message and each of the one or more downlink messages.

A non-transitory computer-readable medium storing code is described. The code may include instructions executable by one or more processors to receive control information that schedules the UE to transmit an uplink message that is associated with repetition across one or more full duplex slots, receive signaling that schedules the UE to receive one or more downlink messages across the one or more full duplex slots, where at least one of the one or more downlink messages overlaps in time with at least one repetition of the uplink message, and communicate, during each full duplex slot of the one or more full duplex slots, a repetition of the uplink message or a downlink message of the one or more downlink messages based on a respective priority associated with each repetition of the uplink message and each of the one or more downlink messages.

In some examples of the method, UEs, and non-transitory computer-readable medium described herein, the one or more full duplex slots includes a set of multiple full duplex slots and the method, apparatuses, and non-transitory computer-readable medium may include further operations, features, means, or instructions for transmitting, during each full duplex slot of the set of multiple full duplex slots, the repetition of the uplink message based on the respective priority associated with each repetition of the uplink message being greater than the respective priority of each of the one or more downlink messages and dropping, during each full duplex slot of the set of multiple full duplex slots, the one or more downlink messages based on the respective priority associated with each repetition of the uplink message being greater than the respective priority of each of the one or more downlink messages.

In some examples of the method, UEs, and non-transitory computer-readable medium described herein, the one or more full duplex slots includes a set of multiple full duplex slots, the uplink message may be associated with a first subset of repetitions across a first subset of full duplex slots of the set of multiple full duplex slots, the uplink message may be associated with a second subset of repetitions across a second subset of full duplex slots of the set of multiple full duplex slots, and the second subset of full duplex slots may be subsequent to the first subset of full duplex slots.

In some examples of the method, UEs, and non-transitory computer-readable medium described herein, the first subset of repetitions may be associated with a first priority that may be greater than the respective priority of the one or more downlink messages and the method, apparatuses, and non-transitory computer-readable medium may include further operations, features, means, or instructions for transmitting, during the first subset of full duplex slots, the first subset of repetitions of the uplink message based on the first subset of repetitions being associated with the first priority.

Some examples of the method, UEs, and non-transitory computer-readable medium described herein may further include operations, features, means, or instructions for receiving a downlink message of the one or more downlink messages based on the downlink message being scheduled for transmission during a full duplex slot of the second subset of full duplex slots and based on the downlink message being a physical downlink control channel message.

In some examples of the method, UEs, and non-transitory computer-readable medium described herein, the second subset of repetitions may be associated with a first physical layer priority and the method, apparatuses, and non-transitory computer-readable medium may include further operations, features, means, or instructions for receiving a downlink message of the one or more downlink messages based on the downlink message being scheduled for transmission during a full duplex slot of the second subset of full duplex slots and based on the downlink message being associated with a second physical layer priority that may be greater than the first physical layer priority.

In some examples of the method, UEs, and non-transitory computer-readable medium described herein, a first full duplex slot of the one or more full duplex slots may be scheduled with a physical uplink message and scheduled with a semi-persistent scheduling physical downlink message and the method, apparatuses, and non-transitory computer-readable medium may include further operations, features, means, or instructions for transmitting the physical uplink message based on a first priority associated with the physical uplink message being greater than a second priority associated with the semi-persistent scheduling physical downlink message.

In some examples of the method, UEs, and non-transitory computer-readable medium described herein, a second full duplex slot of the one or more full duplex slots may be scheduled for the UE to transmit a feedback message associated with the semi-persistent scheduling physical downlink message.

Some examples of the method, UEs, and non-transitory computer-readable medium described herein may further include operations, features, means, or instructions for dropping the feedback message based on dropping the semi-persistent scheduling physical downlink message.

Some examples of the method, UEs, and non-transitory computer-readable medium described herein may further include operations, features, means, or instructions for transmitting the feedback message as a negative acknowledgement message based on dropping the semi-persistent scheduling physical downlink message.

In some examples of the method, UEs, and non-transitory computer-readable medium described herein, the control information may be DCI associated with dynamic scheduling, the signaling may be RRC signaling associated with semi-static scheduling, the uplink message may be a PUCCH, a PUSCH, a SRS, or a PRACH, and the one or more downlink messages may be one or more of a PDSCH, a physical downlink controller channel, or a CSI-RS.

A method by a network entity is described. The method may include outputting, at a first time, control information that schedules a UE to receive a downlink message that is associated with repetition across one or more full duplex slots, outputting signaling that schedules the UE to transmit one or more uplink messages across the one or more full duplex slots, where at least one uplink message of the one or more uplink messages overlaps in time with at least one repetition of the downlink message, and communicating, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time.

A network entity is described. The network entity may include one or more memories storing processor executable code, and one or more processors coupled with the one or more memories. The one or more processors may individually or collectively be operable to execute the code to cause the network entity to output, at a first time, control information that schedules a UE to receive a downlink message that is associated with repetition across one or more full duplex slots, output signaling that schedules the UE to transmit one or more uplink messages across the one or more full duplex slots, where at least one uplink message of the one or more uplink messages overlaps in time with at least one repetition of the downlink message, and communicate, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time.

Another network entity is described. The network entity may include means for outputting, at a first time, control information that schedules a UE to receive a downlink message that is associated with repetition across one or more full duplex slots, means for outputting signaling that schedules the UE to transmit one or more uplink messages across the one or more full duplex slots, where at least one uplink message of the one or more uplink messages overlaps in time with at least one repetition of the downlink message, and means for communicating, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time.

A non-transitory computer-readable medium storing code is described. The code may include instructions executable by one or more processors to output, at a first time, control information that schedules a UE to receive a downlink message that is associated with repetition across one or more full duplex slots, output signaling that schedules the UE to transmit one or more uplink messages across the one or more full duplex slots, where at least one uplink message of the one or more uplink messages overlaps in time with at least one repetition of the downlink message, and communicate, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time.

In some examples of the method, network entities, and non-transitory computer-readable medium described herein, the one or more full duplex slots includes a set of multiple full duplex slots and the method, apparatuses, and non-transitory computer-readable medium may include further operations, features, means, or instructions for outputting, during each full duplex slot of the set of multiple full duplex slots, the repetition of the downlink message based on the respective priority associated with each repetition of the downlink message being greater than the respective priority of each of the one or more uplink messages.

In some examples of the method, network entities, and non-transitory computer-readable medium described herein, the one or more full duplex slots includes a set of multiple full duplex slots, the downlink message may be associated with a first subset of repetitions across a first subset of full duplex slots of the set of multiple full duplex slots, the downlink message may be associated with a second subset of repetitions across a second subset of full duplex slots of the set of multiple full duplex slots, and the second subset of full duplex slots may be subsequent to the first subset of full duplex slots.

In some examples of the method, network entities, and non-transitory computer-readable medium described herein, the first subset of repetitions may be associated with a first priority that may be greater than the respective priority of the one or more uplink messages and the method, apparatuses, and non-transitory computer-readable medium may include further operations, features, means, or instructions for outputting, during the first subset of full duplex slots, the first subset of repetitions of the downlink message based on the first subset of repetitions being associated with the first priority.

Some examples of the method, network entities, and non-transitory computer-readable medium described herein may further include operations, features, means, or instructions for obtaining an uplink message of the one or more uplink messages based on the uplink message being scheduled for transmission during a full duplex slot of the second subset of full duplex slots and based on the uplink message being a random access message.

In some examples of the method, network entities, and non-transitory computer-readable medium described herein, the second subset of repetitions may be associated with a first physical layer priority and the method, apparatuses, and non-transitory computer-readable medium may include further operations, features, means, or instructions for obtaining an uplink message of the one or more uplink messages based on the uplink message being scheduled for transmission during a full duplex slot of the second subset of full duplex slots and based on the uplink message being associated with a second physical layer priority that may be greater than the first physical layer priority.

In some examples of the method, network entities, and non-transitory computer-readable medium described herein, the one or more full duplex slots includes a single full duplex slot scheduled with a downlink message via the control information and scheduled with an uplink message via the signaling, a first portion of the uplink message spans a first subset of symbols of the single full duplex slot that may be within the transmission timeline, and a second portion of the uplink message spans a second subset of symbols of the single full duplex slot that may be subsequent to the transmission timeline.

Some examples of the method, network entities, and non-transitory computer-readable medium described herein may further include operations, features, means, or instructions for obtaining, from the UE, an indication that the UE may be configured with a cancellation capability to partially cancel messages scheduled for full duplex symbols and obtaining the first portion of the uplink message based on the first portion of the uplink message spanning the first subset of symbols within the transmission timeline and based on obtaining the cancellation capability.

Some examples of the method, network entities, and non-transitory computer-readable medium described herein may further include operations, features, means, or instructions for obtaining the first portion of the uplink message based on the first portion of the uplink message spanning the first subset of symbols within the transmission timeline and based on the uplink message being a SRS.

In some examples of the method, network entities, and non-transitory computer-readable medium described herein, the control information may be DCI associated with dynamic scheduling, the signaling may be RRC signaling associated with semi-static scheduling, the downlink message may be a PDSCH or a CSI-RS, and the one or more uplink messages may be one or more of a PUCCH, a PUSCH, a SRS, or a PRACH.

A method by a network entity is described. The method may include outputting control information that schedules a UE to transmit an uplink message that is associated with repetition across one or more full duplex slots, outputting signaling that schedules the UE to receive one or more downlink messages across the one or more full duplex slots, where at least one of the one or more downlink messages overlaps in time with at least one repetition of the uplink message, and communicating, during each full duplex slot of the one or more full duplex slots, a repetition of the uplink message or a downlink message of the one or more downlink messages based on a respective priority associated with each repetition of the uplink message and each of the one or more downlink messages.

A network entity is described. The network entity may include one or more memories storing processor executable code, and one or more processors coupled with the one or more memories. The one or more processors may individually or collectively be operable to execute the code to cause the network entity to output control information that schedules a UE to transmit an uplink message that is associated with repetition across one or more full duplex slots, output signaling that schedules the UE to receive one or more downlink messages across the one or more full duplex slots, where at least one of the one or more downlink messages overlaps in time with at least one repetition of the uplink message, and communicate, during each full duplex slot of the one or more full duplex slots, a repetition of the uplink message or a downlink message of the one or more downlink messages based on a respective priority associated with each repetition of the uplink message and each of the one or more downlink messages.

Another network entity is described. The network entity may include means for outputting control information that schedules a UE to transmit an uplink message that is associated with repetition across one or more full duplex slots, means for outputting signaling that schedules the UE to receive one or more downlink messages across the one or more full duplex slots, where at least one of the one or more downlink messages overlaps in time with at least one repetition of the uplink message, and means for communicating, during each full duplex slot of the one or more full duplex slots, a repetition of the uplink message or a downlink message of the one or more downlink messages based on a respective priority associated with each repetition of the uplink message and each of the one or more downlink messages.

A non-transitory computer-readable medium storing code is described. The code may include instructions executable by one or more processors to output control information that schedules a UE to transmit an uplink message that is associated with repetition across one or more full duplex slots, output signaling that schedules the UE to receive one or more downlink messages across the one or more full duplex slots, where at least one of the one or more downlink messages overlaps in time with at least one repetition of the uplink message, and communicate, during each full duplex slot of the one or more full duplex slots, a repetition of the uplink message or a downlink message of the one or more downlink messages based on a respective priority associated with each repetition of the uplink message and each of the one or more downlink messages.

In some examples of the method, network entities, and non-transitory computer-readable medium described herein, the one or more full duplex slots includes a set of multiple full duplex slots and the method, apparatuses, and non-transitory computer-readable medium may include further operations, features, means, or instructions for obtaining, during each full duplex slot of the set of multiple full duplex slots, the repetition of the uplink message based on the respective priority associated with each repetition of the uplink message being greater than the respective priority of each of the one or more downlink messages.

In some examples of the method, network entities, and non-transitory computer-readable medium described herein, the one or more full duplex slots includes a set of multiple full duplex slots, the uplink message may be associated with a first subset of repetitions across a first subset of full duplex slots of the set of multiple full duplex slots, the uplink message may be associated with a second subset of repetitions across a second subset of full duplex slots of the set of multiple full duplex slots, and the second subset of full duplex slots may be subsequent to the first subset of full duplex slots.

In some examples of the method, network entities, and non-transitory computer-readable medium described herein, the first subset of repetitions may be associated with a first priority that may be greater than the respective priority of the one or more downlink messages and the method, apparatuses, and non-transitory computer-readable medium may include further operations, features, means, or instructions for obtaining, during the first subset of full duplex slots, the first subset of repetitions of the uplink message based on the first subset of repetitions being associated with the first priority.

Some examples of the method, network entities, and non-transitory computer-readable medium described herein may further include operations, features, means, or instructions for outputting a downlink message of the one or more downlink messages based on the downlink message being scheduled for transmission during a full duplex slot of the second subset of full duplex slots and based on the downlink message being a physical downlink control channel message.

In some examples of the method, network entities, and non-transitory computer-readable medium described herein, the second subset of repetitions may be associated with a first physical layer priority and the method, apparatuses, and non-transitory computer-readable medium may include further operations, features, means, or instructions for outputting a downlink message of the one or more downlink messages based on the downlink message being scheduled for transmission during a full duplex slot of the second subset of full duplex slots and based on the downlink message being associated with a second physical layer priority that may be greater than the first physical layer priority.

In some examples of the method, network entities, and non-transitory computer-readable medium described herein, a first full duplex slot of the one or more full duplex slots may be scheduled with a physical uplink message and scheduled with a semi-persistent scheduling physical downlink message and the method, apparatuses, and non-transitory computer-readable medium may include further operations, features, means, or instructions for obtaining the physical uplink message based on a first priority associated with the physical uplink message being greater than a second priority associated with the semi-persistent scheduling physical downlink message.

In some examples of the method, network entities, and non-transitory computer-readable medium described herein, a second full duplex slot of the one or more full duplex slots may be scheduled for the UE to transmit a feedback message associated with the semi-persistent scheduling physical downlink message.

Some examples of the method, network entities, and non-transitory computer-readable medium described herein may further include operations, features, means, or instructions for obtaining the feedback message as a negative acknowledgement message based on dropping the semi-persistent scheduling physical downlink message.

In some examples of the method, network entities, and non-transitory computer-readable medium described herein, the control information may be DCI associated with dynamic scheduling, the signaling may be RRC signaling associated with semi-static scheduling, the uplink message may be a PUCCH, a PUSCH, a SRS, or a PRACH, and the one or more downlink messages may be one or more of a PDSCH, a physical downlink controller channel, or a CSI-RS.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for collision handling between semi-static and dynamic scheduling in accordance with one or more aspects of the present disclosure.

FIG. 2 shows an example of a wireless communications system that supports techniques for collision handling between semi-static and dynamic scheduling in accordance with one or more aspects of the present disclosure.

FIGS. 3A through 3C each show an example of a subband full duplex (SBFD) collision resolution procedure that supports techniques for collision handling between semi-static and dynamic scheduling in accordance with one or more aspects of the present disclosure.

FIG. 4 shows an example of a process flow that supports techniques for collision handling between semi-static and dynamic scheduling in accordance with one or more aspects of the present disclosure.

FIG. 5 shows an example of a process flow that supports techniques for collision handling between semi-static and dynamic scheduling in accordance with one or more aspects of the present disclosure.

FIGS. 6 and 7 show block diagrams of devices that support techniques for collision handling between semi-static and dynamic scheduling in accordance with one or more aspects of the present disclosure.

FIG. 8 shows a block diagram of a communications manager that supports techniques for collision handling between semi-static and dynamic scheduling in accordance with one or more aspects of the present disclosure.

FIG. 9 shows a diagram of a system including a device that supports techniques for collision handling between semi-static and dynamic scheduling in accordance with one or more aspects of the present disclosure.

FIGS. 10 and 11 show block diagrams of devices that support techniques for collision handling between semi-static and dynamic scheduling in accordance with one or more aspects of the present disclosure.

FIG. 12 shows a block diagram of a communications manager that supports techniques for collision handling between semi-static and dynamic scheduling in accordance with one or more aspects of the present disclosure.

FIG. 13 shows a diagram of a system including a device that supports techniques for collision handling between semi-static and dynamic scheduling in accordance with one or more aspects of the present disclosure.

FIGS. 14 through 17 show flowcharts illustrating methods that support techniques for collision handling between semi-static and dynamic scheduling in accordance with one or more aspects of the present disclosure.

### DETAILED DESCRIPTION

In some examples, a network entity and a user equipment (UE) may perform wireless communications in accordance with a subband full duplex (SBFD) operation. For example, SBFD operates in accordance with a communication scheme, where a single frequency spectrum band may be partitioned into sub-bands for downlink and uplink transmissions. As such, SBFD may allow for the UE and the network entity to communicate uplink and downlink messages concurrently. In some examples of SBFD, the network entity may dynamically schedule downlink messages (e.g., via downlink control information (DCI)) and semi-statically configure the UE with uplink message transmission (e.g., via radio resource control (RRC) signaling). In some examples of SBFD, the network entity may dynamically schedule the UE to transmit uplink messages (e.g., via DCI) and semi-statically configure the UE to receive a downlink message (e.g., via RRC signaling).

In some cases, however, a link direction indication (LDI) may not be supported, nor provided for one or more SBFD symbols. For example, LDI is a mechanism used in radio communication to provide information about the direction of a wireless link. If LDI is not supported for SBFD resources where an uplink message and a downlink message are concurrently scheduled, then the network entity and UE may determine whether to drop one or more of the uplink message and the downlink message. However, current standards have not defined a protocol for collision handling in cases where downlink messages, uplink messages, or both, are dynamically scheduled with repetition across a set of SBFD slots. In some cases, the UE and network entity may be configured to perform collision techniques used for flexible symbols on a single carrier. However, such collision techniques associated with flexible symbols may not explicitly support techniques for managing collisions that may occur during SBFD symbols. Additionally, or alternatively, the collision techniques used for flexible symbols may not define one or more rules to resolve dynamic scheduling of uplink and downlink communications associated with repetition across a set of SBFD slots.

As such, the UE and network entity may operate in accordance with a collision resolution protocol defined for SBFD symbols according to the techniques described herein. In some examples, SBFD collision resolution procedure may define collision resolution techniques for dynamically scheduled downlink messages and semi-statically configured uplink messages in accordance with a cancelation capability of the UE. In such examples, the UE may determine a duration between reception of a DCI that dynamically schedules a downlink message and a starting time to transmit an uplink message to determine whether to cancel, partially cancel, or transmit the uplink message.

In some examples, a downlink message may be dynamically scheduled with repetition across a set of SBFDs, where one or more SBFDs of the set of SBFDs may also be semi-statically configured for the transmission of uplink messages. In some examples, the UE and network entity determine that each repetition of downlink message are treated as a dynamic grant that has a higher priority than the semi-statically configured uplink messages. In some examples, the UE and network entity may determine that a first subset of the repetitions (e.g., a first K repetitions) are treated as dynamic grant scheduled and that the remaining repetitions are treated as being configured by higher layers. In some examples, the UE and network entity may determine that, other than for the first K repetitions, a repetition is dropped if it temporally overlaps with a random access (RACH) occasion message. In some examples, the UE and network entity determine that the first K repetitions have high priority, and the other repetitions have a low physical layer (PHY) priority, which may be dropped if overlapping with uplink messages of a high PHY priority. Similar techniques are described for cases where an uplink message is dynamically scheduled with repetition across a set of SBFDs, where one or more SBFDs of the set of SBFDs may also be semi-statically configured for the transmission of downlink messages.

Aspects of the disclosure are initially described in the context of wireless communications systems, SBFD collision resolution procedures, and process flows. Aspects of the disclosure are further illustrated by and described with reference to apparatus diagrams, system diagrams, and flowcharts that relate to techniques for collision handling between semi-static and dynamic scheduling.

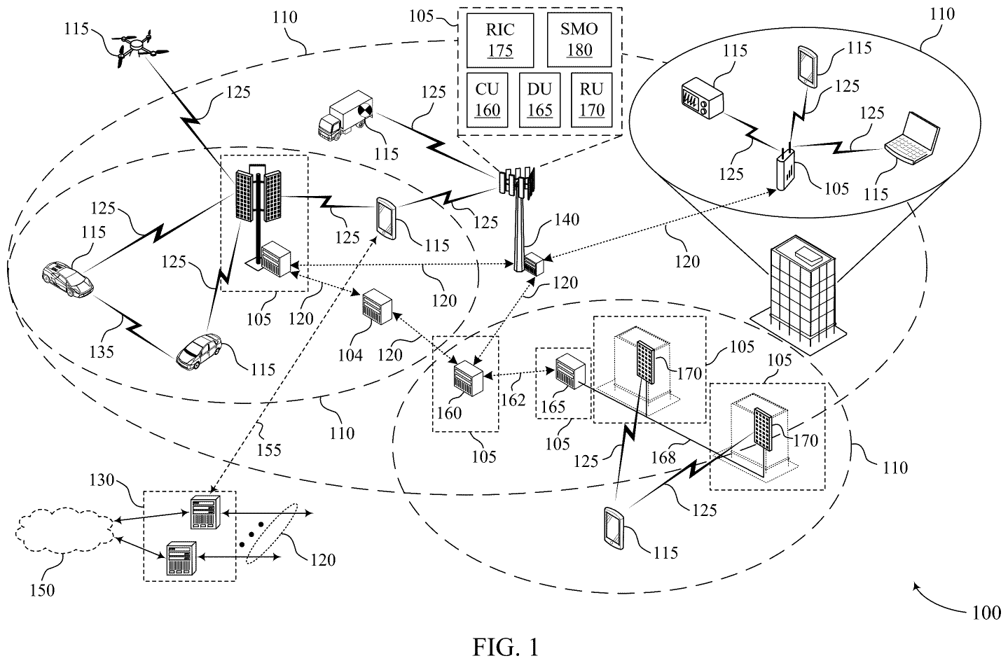

FIG. 1 shows an example of a wireless communications system 100 that supports techniques for collision handling between semi-static and dynamic scheduling in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency spectrum band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency spectrum bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of wireless communications system 100, a UE 115 and a network entity 105 may operate in accordance with a collision resolution protocol defined for SBFD symbols according to the techniques described herein. In some examples, the SBFD collision resolution procedure may define collision resolution techniques for dynamically scheduled downlink messages and semi-statically configured uplink messages in accordance with a cancelation capability of the UE 115. In such examples, the UE 115 may determine a duration of time between reception of a DCI that dynamically schedules a downlink message and a starting time to transmit an uplink message to determine whether to cancel, partially cancel, or transmit the uplink message.

In some examples, a downlink message may be dynamically scheduled using repetition across a set of SBFDs, where one or more SBFDs of the set of SBFDs may be semi-statically configured for the transmission of uplink messages. In some examples, the UE 115 and network entity 105 may determine that each repetition of downlink message are to be treated as a dynamic grant that has a higher priority than the semi-statically configured uplink messages. In some examples, the UE 115 and network entity 105 may determine that a first subset of the repetitions (e.g., a first K repetitions) are treated as dynamic grant scheduled and the remaining repetitions are treated as being configured by higher layer. In some examples, the UE 115 and network entity 105 may determine that other than for the first K repetitions, a repetition may be dropped if the repetition temporally overlaps with a random access occasion message. In some examples, the UE 115 and network entity 105 determine that the first K repetitions have high priority, and the other repetitions have a low PHY priority, which may be dropped if overlapping with uplink messages of a high PHY priority. Respective techniques are described for cases where an uplink message is dynamically scheduled with repetition across a set of SBFDs, where one or more SBFDs of the set of SBFDs may also be semi-statically configured for the transmission of downlink messages.

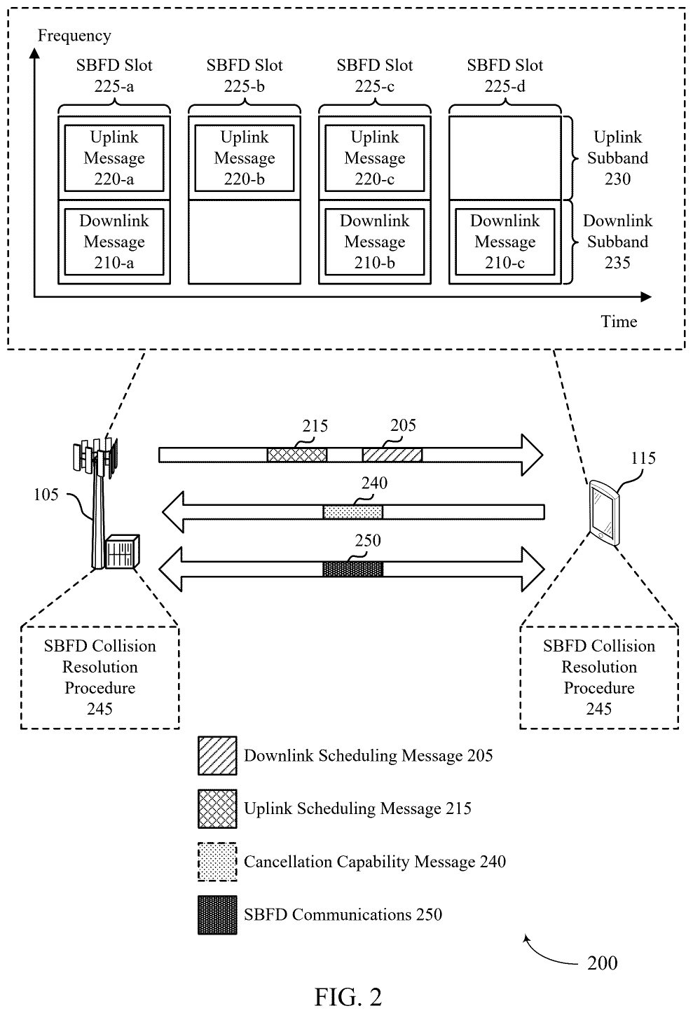

FIG. 2 shows an example of a wireless communications system 200 that supports techniques for collision handling between semi-static and dynamic scheduling in accordance with one or more aspects of the present disclosure. The wireless communications system 200 may implement or may be implemented by aspects of the wireless communications system 100. For example, the wireless communications system 200 may include a UE 115, which may be an example of a UE 115 as described herein. The wireless communications system 200 may include a network entity 105, which may be an example of a network entity 105 as described herein.

In some examples of wireless communications system 200, the UE 115 and the network entity 105 may communicate one or more uplink and downlink transmissions. For example, the UE 115 may receive a downlink scheduling message 205 and an uplink scheduling message 215. In some examples, the downlink scheduling message 205 may schedule the UE 115 to receive one or more downlink messages 210 over one or more slots (e.g., downlink message 210-a, 210-b, and 210-c). Additionally, or alternatively, the one or more downlink messages 210 may include different types of downlink transmissions such as one or more of a physical downlink shared channel (PDSCH) transmission, a physical downlink control channel (PDCCH) transmission, a channel state information (CSI) reference signal (CSI-RS), among other example transmission types. In some examples, the uplink scheduling message 215 may schedule the UE 115 to transmit one or more uplink messages 220 over one or more slots (e.g., uplink message 220-a, 220-b, and 220-c). Additionally, or alternatively, the one or more uplink messages 220 may include different types of uplink transmissions such as one or more of a physical uplink shared channel (PUSCH) transmission, a physical uplink control channel (PUCCH) transmission, a sounding reference signal (SRS), a physical random access channel (PRACH) transmission (e.g., during a valid random access occasion), among other example transmissions. Additionally, while FIG. 2 illustrates the UE 115 receiving the downlink scheduling message 205 and the uplink scheduling message 215 from a same network entity 105, the UE 115 may receive the downlink scheduling message 205 from a first network entity 105 and the uplink scheduling message 215 from a second network entity 105.

As illustrated in FIG. 2, the uplink messages 220 and the downlink messages 210 may be scheduled across a set of SBFD slots 225 (e.g., SBFD slot 225-a, 225-b, 225-c, and 225-d). For example, an SBFD slot of the set of SBFD slots 225 may be a slot that enables concurrent uplink and downlink communications on a same (e.g., shared) frequency subband. For instance, a first portion of the frequency spectrum band may be an uplink subband 230 allocated for the UE 115 to transmit the uplink messages 220, and a second portion of the frequency spectrum band may be a downlink subband 235 allocated for the UE 115 to receive the downlink messages 210. As such, SBFD operations may increase the spectral efficiency and capacity of the wireless communications system 200, thereby increasing a data throughput and increasing the quality of service to the UE 115. While various examples discussed herein are directed to SBFD implementations, the various described techniques may also be applicable to full-duplex communications in which downlink subbands 235 and uplink subbands 230 partially overlap or completely overlap. Further, while one downlink subband 235 and one uplink subband 230 are illustrated in each SBFD slot of the set of SBFD slots 225, techniques discussed herein may apply where two or more downlink subbands 235, or two or more uplink subbands 230, are present in the set of SBFD slots 225.

In some examples, the network entity 105 may schedule the downlink messages 210 and the uplink messages 220 across the set of SBFD slots 225 using various scheduling techniques. In some examples, a first type of scheduling may be dynamic scheduling (e.g., via DCI) which may refer to the allocation of resources on a per-transmission basis. For instance, wireless communication resources may be allocated dynamically depending on the current channel conditions, traffic load, and quality of service parameters. In dynamic scheduling, resources may be allocated and reallocated on-the-fly, allowing the wireless communications system 200 to adapt quickly to changes in network conditions and traffic loading. As such, the network entity 105 may use dynamic scheduling for environments with rapidly changing channel conditions and traffic loads, to allow for efficient resource utilization and increased system throughput.

In some examples, a second type of scheduling may be semi-static scheduling (e.g., via RRC signaling or other higher layer signaling) which may refer to the allocation of resources based on pre-defined resource allocation patterns. For instance, semi-static scheduling may allocate wireless communication resources based on predetermined patterns that the network entity 105 may update periodically. These patterns may be based on factors such as channel quality, user priority, and traffic load, and may be updated less frequently compared to dynamic scheduling. As such, the network entity 105 may use semi-static scheduling for environments with relatively stable channel conditions and traffic loads, to reduce the overhead associated with frequent resource allocation updates.

In some cases, the downlink scheduling message 205 and the uplink scheduling message 215 may be associated with different types of scheduling. In some examples (e.g., a first case), the network entity 105 may dynamically schedule the downlink scheduling message 205 and semi-statically schedule the uplink scheduling message 215. In some examples, (e.g., a second case), the network entity 105 may dynamically schedule the uplink scheduling message 215 and semi-statically schedule the downlink scheduling message 205. As such, the network entity 105 may schedule the UE 115 with the uplink messages 220 and the downlink messages 210 using different scheduling schemes. Additionally, as illustrated in FIG. 2, one or more of the uplink messages 220 and the downlink messages 210 may at least partially overlap in time. For instance, uplink message 220-a and the downlink message 210-a may both be scheduled for communication over SBFD slot 225-a, and uplink message 220-c and downlink message 210-b may both be scheduled for communication over SBFD slot 225-c.

To assist in the concurrent communication of an uplink message 220 and a downlink message 210 over a same SBFD slot of the set of SBFD slots 225, the network entity 105 and UE 115 may operate in accordance with an LDI. For example, an LDI may support an ability for the UE 115 to determine the direction of incoming signals from the network entity 105 (e.g., and vice versa). Such use of an LDI may enable the UE 115 and network entity 105 to perform antenna techniques that improve the reliability of concurrent communication of uplink and downlink transmissions. In some cases, however, the network entity 105 or UE 115 may not support use of an LDI or the network entity 105 and UE 115 may not provide an LDI for one or more of the set of SBFD slots 225. As such, concurrent communication during an SBFD slot of the set of SBFD slots 225 where an LDI is not indicated may result in an uplink and downlink collisions.

To reduce the occurrence of uplink and downlink transmission collisions, the UE 115 and network entity 105 may operate in accordance with one or more collision handling techniques used for flexible symbols on a single carrier in unpaired spectrum. For example, in a first collision case (e.g., dynamically scheduled downlink reception and semi-statically configured uplink transmission) during an SBFD slot of the set of SBFD slots 225 where the UE 115 is SBFD-aware, the UE 115 may leverage collision handling principles used for operation on flexible symbols on a single carrier in unpaired spectrum (e.g., the UE 115 cancels the semi-statically configured uplink message and receives the dynamically configured uplink message). In a second collision case (e.g., semi-statically configured downlink reception and dynamically scheduled uplink transmission) during an SBFD slot of the set of SBFD slots 225 where the UE 115 is SBFD-aware, the UE 115 may leverage collision handling principles used for operation on flexible symbols on a single carrier in unpaired spectrum (e.g., the UE 115 refrains from receiving the semi-statically configured downlink message and transmits the dynamically configured uplink message).

In some cases, however, such collision techniques used for flexible symbols on a single carrier may not support collision handling for various conditions associated with SBFD operation. Additionally, or alternatively, the collision techniques used for flexible symbols on a single carrier may not define one or more rules to resolve dynamic scheduling of uplink and downlink communications associated with repetition across a set of SBFD slots 225. As such, it may be advantageous for the UE 115 and network entity 105 to operate in accordance with collision resolution protocol defined for SBFD symbols, and the network entity 105 and the UE 115 may utilize an SBFD collision resolution procedure 245 according to the techniques described herein.

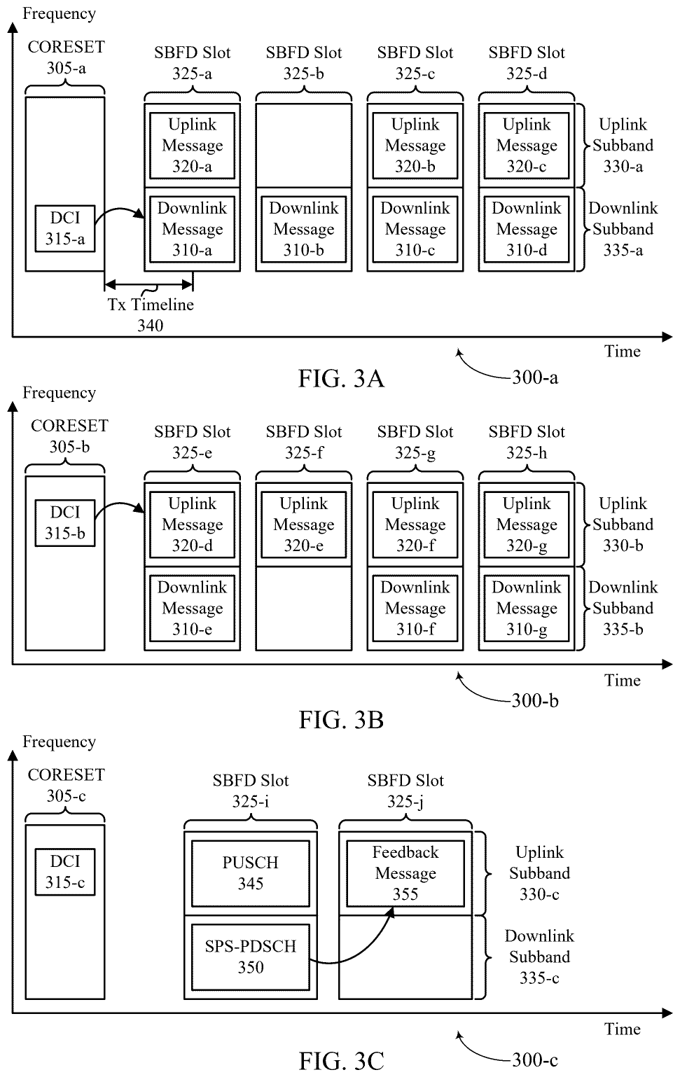

In some examples, the SBFD collision resolution procedure 245 may define collision resolution techniques for dynamically scheduled downlink messages (e.g., downlink messages 210) and semi-statically configured uplink messages (e.g., uplink messages 220) in accordance with a cancelation capability of the UE 115. For example, with reference to FIG. 2, the network entity 105 may dynamically schedule downlink message 210-a via a DCI associated CORESET, where the DCI is transmitted at a first time, and may semi-statically schedule uplink message 220-a. In such examples, the UE 115 may determine a duration between a start of the uplink message 220-a relative to an end of the DCI associated with the CORESET to determine whether the duration is within a transmission timeline associated with the UE 115. For example, the transmission timeline may be associated with an uplink message preparation time corresponding to a processing capability of the UE 115. In examples where the start of the uplink message 220-a is within the transmission timeline, the UE 115 may determine whether to perform a partial cancellation of the remaining portion of the message after the transmission timeline, or no cancellation of the uplink message 220-a in accordance with a partial cancellation capability of the UE 115. For instance, as illustrated in FIG. 2, the UE 115 may optionally transmit a cancellation capability message 240 to the network entity 105. As such, the UE 115 may perform the SBFD collision resolution procedure 245 based on whether the UE 115 is configured with the cancellation capability and based on whether the UE 115 determines to transmit the cancellation capability message 240 to the network entity 105. Further discussion of partial cancellation of an uplink message 220 based on the transmission timeline and the cancellation capability of the UE 115 is described herein, including with reference to FIG. 3A. In examples where the start of the uplink message 220-a is after the transmission timeline, the UE may cancel the uplink message and receive the downlink message.

In some examples, the SBFD collision resolution procedure 245 may define collision resolution techniques for a dynamically scheduled downlink message (e.g., from downlink messages 210) associated with repetition across a set of SBFD slots 225 and semi-statically configured uplink messages (e.g., uplink messages 220) scheduled across one or more of the sets of SBFD slots 225. Further discussion of such collision resolution techniques are described herein, including with reference to FIG. 3A.

In some examples, the SBFD collision resolution procedure 245 may define collision resolution techniques for a dynamically scheduled uplink message associated with repetition across a set of SBFD slots 225 and semi-statically configured downlink messages 210 scheduled across one or more of the sets of SBFD slots 225. Further discussion of such collision resolution techniques are described herein, including with reference to FIG. 3B.

In some examples, the SBFD collision resolution procedure 245 may define collision resolution techniques for instances where the UE 115 and network entity 105 drop a scheduled SPS-PDSCH. For instance, when the SPS-PDSCH is dropped, the UE 115 may use the SBFD collision resolution procedure 245 to determine whether to transmit a feedback message associated with the dropped SPS-PDSCH. Further discussion of such collision resolution techniques are described herein, including with reference to FIG. 3C.

Based on performing the SBFD collision resolution procedure, the UE 115 and the network entity 105 may select which of the uplink messages 220 and which of the downlink messages 210 to transmit, respectively, during each of the scheduled SBFD slots of the set of SBFD slots 225. As such, the network entity 105 and the UE 115 may communicate the selected uplink messages 220 and the selected downlink messages 210 in accordance with SBFD communications 250.

FIG. 3A through 3C each show an example of an SBFD collision resolution procedure 300 that supports techniques for collision handling between semi-static and dynamic scheduling in accordance with one or more aspects of the present disclosure. Each of SBFD collision resolution procedure 300-a, 300-b, and 300-c may implement or be implemented by wireless communications system 100 and 200. For example, SBFD collision resolution procedure 300-a, 300-b, and 300-c may be respective examples of the techniques of SBFD collision resolution procedure 245 as described with reference to FIG. 2. As such, the techniques described with reference to FIGS. 3A through 3C may be performed by a UE 115 (e.g., the UE 115 of FIG. 2), a network entity 105 (e.g., the network entity 105 of FIG. 2), or both.

FIG. 3A may be implemented in cases of dynamically scheduled downlink reception and semi-statically configured uplink transmission. For example, as illustrated in FIG. 3A a network entity 105 may transmit DCI 315-a included in or associated with a CORESET 305-a, where the DCI 315-a dynamically schedules a UE 115 to receive one or more downlink messages 310 (e.g., one or more of downlink messages 310-a, 310-b, 310-c, and 310-d). Additionally, the network entity 105 may transmit higher layer signaling (e.g., RRC signaling) that schedules the UE 115 to transmit one or more uplink messages 320 (e.g., uplink message 320-a, 320-b, and 320-c). As illustrated in FIG. 3A the one or more uplink messages 320 and the one or more downlink messages 310 may be scheduled across a set of SBFD slots 325 (e.g., SBFD slot 325-a, 325-b, 325-c, and 325-d). Additionally, the one or more uplink messages may be scheduled in an uplink subband 330-a and the one or more downlink messages may be scheduled in a downlink subband 335-a.

As illustrated in FIG. 3A, a transmission timeline 340 may span a duration with respect to an end of the DCI 315-a transmission. In some examples, the transmission timeline may be an uplink message (e.g., PUSCH or PUCCH) preparation time corresponding to a UE 115 processing capability. For instance, the transmission timeline 340 may represent an amount of time of the UE 115 to transition from receiving the DCI 315-a that dynamically schedules the one or more downlink messages 310 and to transmitting an uplink message 320. As described with reference to FIG. 2, the UE 115 may support or be configured for partial cancellation of uplink messages 320 in SBFD symbols (e.g., partialCancellation).

In some examples, for operation on a single carrier in unpaired spectrum, if the UE 115 is configured by higher layers to transmit an uplink message 320 (e.g., SRS, PUCCH, PUSCH, or PRACH) within the usable uplink physical resource block (PRB) of the uplink subband 330-a in a set of SBFD symbols of an SBFD slot 325 (e.g., the SBFD slot 325-a), and the UE 115 detects the DCI 315-a indicating to the UE 115 to receive one or more downlink messages 310 (e.g., CSI-RS or PDSCH) within the downlink usable PRBs of downlink subband 335-a in a subset of symbols from the set of symbols (e.g., the uplink message 320-a and the downlink message 310-a at least partially overlap in time), then UE 115 may resolve the collision based on the associated cancellation capability.

In some examples, the UE 115 may be configured with the cancellation capability, but may refrain from indicating the cancellation capability to the network entity 105 (e.g., the UE 115 refrains from transmitting the cancellation capability message 240, as described with reference to FIG. 2). In such examples, the UE 115 may determine to cancel (e.g., drop) the transmission of the uplink message 320-a (e.g., PUCCH, PUSCH, or PRACH) in the set of SBFD symbols if the first symbol in the set occurs within the transmission timeline 340 relative to a last symbol of a PDCCH reception where the UE 115 detects the DCI 315-a. That is, if the at least a portion of an uplink message is within the transmission timeline 340, the UE 115 may determine to drop the uplink message 320. For instance, in the example of FIG. 3A, the UE 115 may determine to cancel (e.g., drop) the uplink message 320-a based on the uplink message 320-a at least partially overlapping in time with the downlink message 310-a, based on the uplink message 320-a spanning a first portion of SBFD symbols within the transmission timeline, and based on the UE 115 not indicating the cancellation capability to the network entity 105.

In some examples, the UE 115 may be configured with the cancellation capability, and may indicate the cancellation capability to the network entity 105 (e.g., the UE 115 transmits the cancellation capability message 240, as described with reference to FIG. 2). In such examples, the UE 115 may determine to transmit (e.g., not cancel or not drop) a portion of an uplink message 320 (e.g., PUCCH, PUSCH, or PRACH) in SBFD symbols from the set of SBFD symbols that occur within the transmission timeline 340 relative to a last symbol of a PDCCH reception where the UE 115 detects the DCI 315-a. Additionally, the UE 115 may determine to drop (e.g., cancel) the portion of an uplink message 320 in the SBFD symbols from the set of SBFD symbols that occur after the transmission timeline 340. For instance, in the example of FIG. 3A, the UE 115 may transmit a first portion of the uplink message 320-a within the transmission timeline 340 and may cancel (e.g., drop) a second portion of the uplink message 320-a scheduled after the transmission timeline 340.

In some examples, the UE 115 may be scheduled (e.g., via RRC signaling) with an uplink message 320 that is an SRS transmission. In some examples, the UE 115 may transmit the SRS in SBFD symbols from the subset of SBFD symbols that occur within transmission timeline 340 relative to a last symbol of a PDCCH reception where the UE 115 detects the DCI 315-a. Additionally, or alternatively, the UE 115 may cancel (e.g., drop) the SRS transmission in remaining SBFD symbols from the subset of SBFD symbols. For instance, in the example of FIG. 3A, if the uplink message 320-a is an SRS transmission the UE 115 may determine to transmit a first portion of the uplink message 320-a within the transmission timeline 340 and determine to cancel (e.g., drop) a second portion of the uplink message 320-a scheduled after the transmission timeline 340.

In some examples, the UE 115 may not be configured with the cancellation capability. In such examples, the UE 115 may determine not to cancel (e.g., the UE 115 does not drop) the transmission of the uplink message 320-a (e.g., PUCCH, PUSCH, or PRACH) in the set of SBFD symbols if the first symbol in the set occurs within the transmission timeline 340 relative to a last symbol of a PDCCH reception where the UE 115 detects the DCI 315-a. That is, if the at least a portion of an uplink message is within the transmission timeline 340, the UE 115 may determine not to drop the uplink message 320. For instance, in the example of FIG. 3A, the UE 115 may determine not to cancel (e.g., not drop) the uplink message 320-a based on the uplink message 320-a at least partially overlapping in time with the downlink message 310-a, based on the uplink message 320-a spanning a first portion of SBFD symbols within the transmission timeline, and based on not being configured with the cancellation capability.

In some cases, of FIG. 3A, the DCI 315-a schedules downlink reception with repetition across multiple SBFD slots 325 (e.g., PDSCH aggregation). For example, each of downlink message 310-a, 310-b, 310-c, and 310-d may be a repetition of a downlink data message (e.g., a PDSCH), where each repetition occurs during a respective SBFD slot 325 (e.g., SBFD slot 325-a, 325-b, 325-c, and 325-d). As such, a collision may occur in one or more of the SBFD slots 325 between a repetition of the one or more downlink messages 310 and an uplink message scheduled via higher layer signaling. For instance, uplink message 320-a may collide with downlink message 310-a, uplink message 320-b may collide with downlink message 310-c, and uplink message 320-c may collide with downlink message 310-d.

To resolve collisions between a dynamically scheduled repetition of the one or more downlink messages 310 and a given uplink message 320, the UE 115 and network entity 105 may operate in accordance with one or more techniques of the SBFD collision resolution procedure 300-a.

In some examples of SBFD collision resolution procedure 300-a, the UE 115 and network entity 105 may define each of the repetitions of the one or more downlink messages 310 as having a first priority associated with dynamic grant scheduling, where the first priority is higher than a respective priority of each of the uplink messages 320, based on the uplink messages 320 being scheduled via higher layer signaling (e.g., associated with a lower layer priority than the dynamic scheduled message). As such, the UE 115 may drop (e.g., cancel) each of uplink message 320-a, 320-b, and 320-c and receive each of downlink message 310-a, 310-b, 310-c, and 310-d. In such examples where the repetitions of the one or more downlink messages 310 and repetitions of the uplink messages 320, the UE 115 may apply a collision handling rule (for each repetition) that allows for the UE 115 to cancel repetitions of the uplink messages 320 and receive repetitions of the one or more downlink messages 310 (if a cancellation timeline for the uplink repetitions is met).

In some examples of SBFD collision resolution procedure 300-a, the UE 115 and network entity 105 may define a first subset of the downlink message 310 repetitions and a second subset of the downlink message 310 repetitions, where the second subset is subsequent to the first subset in time. A first quantity of downlink message 310 repetitions in the first subset may be equal to a configured (e.g. RRC configured) or indicated (e.g., by DCI bitfield) first value (e.g., K) and a second quantity of downlink message 310 repetitions in the second subset may be equal to a difference between a total quantity of repetitions (e.g., N) and the first value (e.g., N-K). In some examples, the first value (e.g., K) may be indicated by the DCI 315-a or may be configured by the network entity 105 (e.g., where K<N). For instance, if the first value is configured as two, then downlink message 310-a and 310-b may be in the first subset of repetitions and downlink message 310-c and 310-d may be in the second subset of repetitions.

In some examples, where the first value (e.g., K) is configured, the network entity 105 and UE 115 may assign the first priority associated with dynamic grant scheduling to the first subset of downlink message 310 repetitions and may assign the second priority associated with higher layer signaling to the second subset of downlink message 310 repetitions, where the first priority is greater than the second priority.

In some examples, where the first value (e.g., K) is configured or indicated, the UE 115 and network entity 105 may determine whether to drop a repetition of the downlink message or to drop an uplink message 320 based on a message type of the uplink message 320. For instance, if downlink message 310-c is determined to be in the second subset of repetitions and the uplink message 320-b is scheduled RACH message during a valid RACH occasion, then the UE 115 may determine to transmit uplink message 320-b and refrain from receiving (e.g., drop or cancel) downlink message 310-c. If, however, the downlink message 310-c is determined to be in the first subset of repetitions and the uplink message 320-b is a scheduled RACH message during a valid RACH occasion, then the UE 115 may determine to drop (e.g., cancel) uplink message 320-b and receive downlink message 310-c.

In some examples, where the first value (e.g., K) is configured or indicated, the UE 115 and network entity 105 may define the first subset of downlink message 310 repetitions to have a high priority and for the second subset of downlink message 310 repetitions to have a low PHY priority, where the second subset of downlink message 310 repetitions may be dropped for overlapping in time with an uplink message 320 associated with a high PHY priority. For instance, if downlink message 310-c is determined to be in the second subset of repetitions associated with a low PHY priority and the uplink message 320-b is associated with a high PHY priority, then the UE 115 may determine to transmit the uplink message 320-b and refrain from receiving (e.g., drop or cancel) the downlink message 310-c.

FIG. 3B may be implemented in cases of dynamically scheduled uplink transmission and semi-statically configured downlink reception. For example, as illustrated in FIG. 3B, a network entity 105 may transmit DCI 315-b included in or associated with a CORESET 305-b, where the DCI dynamically schedules a UE 115 to transmit one or more uplink messages 320 (e.g., one or more of uplink message 320-d, 320-c, 320-f, and 320-g). Additionally, the network entity 105 may transmit higher layer signaling (e.g., RRC signaling) that schedules the UE 115 to transmit one or more downlink messages 310 (e.g., downlink message 310-e, 310-f, and 310-g). As illustrated in FIG. 3B the one or more uplink messages 320 and the one or more downlink messages 310 may be scheduled across a set of SBFD slots 325 (e.g., SBFD slot 325-e, 325-f, 325-g, and 325-h). Additionally, the one or more uplink messages may be scheduled in an uplink subband 330-b and the one or more downlink messages may be scheduled in a downlink subband 335-b.

In some examples, for operation on a single carrier in unpaired spectrum, if the UE 115 is SBFD-aware, and the network entity 105 configures the UE 115 to receive one or more downlink messages 310 (e.g., a PDCCH, a PDSCH, a CSI-RS, or a downlink positioning reference signal (PRS)) within a downlink usable PRB (e.g., downlink subband 335-b) in a set of SBFD symbols of a first SBFD slot 325, the UE 115 may receive the one or more downlink messages 310 if the UE 115 does not detect the DCI 315-b that indicates to the UE 115 to transmit an uplink message 320 (e.g., a PUSCH, a PUCCH, a PRACH, or an SRS) within the usable uplink PRBs (e.g., the uplink subband 330-b) in at least one SBFD symbol of the set of SBFD symbols of the first SBFD slot 325. If the UE 115 does detect the DCI 315-b that indicates the UE 115 to transmit the uplink message 320, the UE 115 may refrain from receiving (e.g., drop or cancel) the one or more downlink messages 310 in the set of SBFD symbols of the SBFD slot 325.

In some cases, the DCI 315-b schedules uplink transmission with repetition across multiple SBFD slots 325 (e.g., using PUSCH or PUCCH aggregation). For example, each of uplink message 320-d, 320-e, 320-f, and 320-g may be a repetition of an uplink data message or an uplink control message (e.g., a PUSCH or PUCCH), where each repetition is transmitted during a respective SBFD slot 325 (e.g., SBFD slot 325-e, 325-f, 325-g, and 325-h). As such, a collision may occur in one or more of the SBFD slots 325 between a repetition of the uplink message 320 and a downlink message scheduled via higher layer signaling. For instance, downlink message 310-e may collide with uplink message 320-d, uplink message 320-f may collide with downlink message 310-f, and uplink message 320-g may collide with downlink message 310-g.

To resolve collisions between a dynamically scheduled repetition of the uplink message 320 and a respective one or more downlink messages 310, the UE 115 and network entity 105 may operate in accordance with one or more techniques of the SBFD collision resolution procedure 300-b.

In some examples of SBFD collision resolution procedure 300-b, the UE 115 and network entity 105 may define each of the repetitions of the uplink message 320 as having a first priority associated with dynamic grant scheduling, where the first priority is higher than a respective priority of each of the one or more downlink messages 310, based on the one or more downlink messages 310 being scheduled via higher layer signaling (e.g., associated with a higher layer priority). As such, the UE 115 may drop (e.g., cancel) each of downlink message 310-e, 310-f, and 310-g and receive each of uplink message 320-d, 320-e, 320-f, and 320-g. In such examples where the repetitions of the one or more downlink message 310 and repetitions of the uplink messages 320, the UE 115 may apply a collision handling rule (for each repetition) that allows for the UE 115 to cancel repetitions of the one or more downlink messages 310 and transmit repetitions of the uplink message 320 based on priority (if a cancellation timeline is met).

In some examples of SBFD collision resolution procedure 300-b, the UE 115 and network entity 105 may define a first subset of the uplink message 320 repetitions and a second subset of the uplink message 320 repetitions, where the second subset is subsequent to the first subset in time. A first quantity of uplink message 320 repetitions in the first subset may be equal to a configured first value (e.g., K) and a second quantity of uplink message 320 repetition in the second subset may be equal to a difference between a total quantity of repetitions (e.g., N) and the first value (e.g., N-K). In some examples, the first value (e.g., K) may be indicated by the DCI 315-b or configured by the network entity 105 (e.g., where K<N). For instance, if the first value is configured as two, then uplink message 320-d and 320-e may be part of the first subset of repetitions and uplink message 320-f and 320-g may be part of the second subset of repetitions.

In some examples, where the first value (e.g., K) is configured, the network entity 105 and UE 115 may define the first subset of uplink message 320 repetitions with the first priority associated with dynamic grant scheduling and may define the second subset of uplink message 320 repetitions with a second priority associated with higher layer signaling, where the first priority is greater than the second priority.

In some examples, where the first value (e.g., K) is configured, the UE 115 and network entity 105 may determine whether to drop a repetition of the uplink message 320 or whether to drop one or more downlink messages 310 based on a message type of the one or more downlink messages 310. For instance, if uplink message 320-f is determined to be in the second subset of repetitions and the downlink message 310-f is a scheduled PDCCH (e.g., search space, CORESET, or monitoring occasion (MO)) the UE 115 may determine to drop (e.g., cancel) the uplink message 320-f and receive the downlink message 310-f. If, however, the uplink message 320-f is determined to be in the first subset of repetitions and the downlink message 310-f is a scheduled PDCCH, then the UE 115 may determine to transmit the uplink message 320-f and refrain from receiving (e.g., drop or cancel) the downlink message 310-f.

In some examples, where the first value (e.g., K) is configured, the UE 115 and network entity 105 may define the first subset of uplink message 320 repetitions to have a high priority and for the second subset of uplink message 320 repetitions to have a low PHY priority, where the second subset of uplink message 320 repetitions may be dropped for overlapping in time with one or more downlink messages 310 associated with a high PHY priority. For instance, if uplink message 320-f is determined to be in the second subset of repetitions associated with a low PHY priority and the downlink message 310-f is associated with a high PHY priority, then the UE 115 may determine to receive downlink message 310-f and drop (e.g., cancel) transmission of uplink message 320-f.

FIG. 3C may be implemented in cases where the UE 115 and the network entity 105 determine to drop an SPS-PDSCH 350. For example, as illustrated in FIG. 3A a network entity 105 may transmit one or more signals (e.g., DCI 315-c) to schedule the UE 115 to transmit a PUSCH 345 and the receive an SPS-PDSCH 350 during an SBFD slot 325-i. For example, as illustrated in FIG. 3C the PUSCH 345 is scheduled in an uplink subband 330-c of the SBFD slot 325-i (e.g., an uplink usable PRB within the uplink subband 330-c in SBFD symbol) and the SPS-PDSCH 350 is scheduled within the downlink subband 335-c of the SBFD slot 325-i (e.g., downlink usable PRB within the downlink subbands 335-c in SBFD symbol). Additionally, the network entity 105 may schedule the UE 115 to transmit a feedback message 355 in SBFD slot 325-j, where the feedback message 355 is associated with reception of the SPS-PDSCH 350. In some examples, one or more signals used to schedule the PUSCH 345 and SPS-PDSCH 350 may be one or more higher layer signals (e.g., RRC signaling), where the PUSCH 345 and the SPS-PDSCH 350 are scheduled semi-statically. As such, the PUSCH 345 and the SPS-PDSCH 350 may not be dynamically scheduled using a DCI 315-c that is included in or associated with a CORESET 305-c.

In some examples of SBFD collision resolution procedure 300-c, the UE 115 and the network entity 105 may determine to drop (e.g., cancel) the SPS-PDSCH 350, and for the UE 115 to transmit the PUSCH 345. In such examples, the UE 115 and network entity 105 may determine whether the UE 115 may drop or transmit the feedback message 355 associated with the SPS-PDSCH 350. In some examples, the UE 115 may determine to drop (e.g., cancel) the feedback message 355 (e.g., drop the PUCCH resource scheduled to carry HARQ information associated with the SPS-PDSCH 350). In some examples, the UE 115 may determine to transmit the feedback message 355. For instance, based on the UE 115 refraining from receiving the SPS-PDSCH 350, the UE 115 may transmit the feedback message 355 as a negative acknowledgement (NACK) message, where the NACK message may be carried on a PUCCH resource scheduled to carry HARQ information associated with the SPS-PDSCH 350.

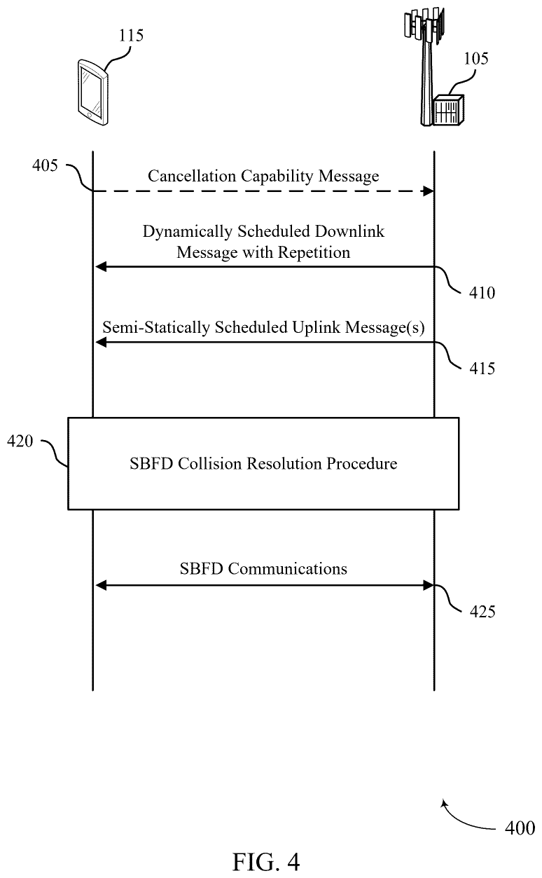

FIG. 4 shows an example of a process flow 400 that supports techniques for collision handling between semi-static and dynamic scheduling in accordance with one or more aspects of the present disclosure. In some examples, process flow 400 may implement aspects of wireless communications system 100, wireless communications system 200, and SBFD collision resolution procedure 300-a. Process flow 400 may include a UE 115 which may be an example of UEs 115, as described with reference to FIGS. 1 through 3. Additionally, process flow 400 may include a network entity 105 which may be an example of a network entity 105, as described with reference to FIGS. 1 through 3. Alternative examples of the following may be implemented, where some steps are performed in a different order than described or are not performed at all. In some cases, steps may include additional features not mentioned below, or further steps may be added. In addition, it is understood that these processes may occur between any quantity of network devices and network device types.

At 405, the UE 115 may optionally transmit a cancellation capability message to the network entity 105 (e.g., the cancellation capability message 240, with reference to FIG. 2). For example, the cancellation capability message may indicate that the UE 115 is configured with a cancellation capability to partially cancel messages scheduled for SBFD symbols.

At 410, the UE 115 may receive at a first time, control information that schedules the UE 115 to receive a downlink message. For example, the downlink message may be associated with repetition across one or more SBFD slots. Additionally, the control information may be an example of DCI 315-a, as described with reference to FIG. 3A. In some examples, the control information may be a DCI associated with dynamic scheduling. In some examples, the downlink message may be a PDSCH message or a CSI-RS message.

At 415, the UE 115 may receive signaling that schedules the UE 115 to transmit one or more uplink messages across the one or more SBFD slots. In some examples, at least one of the one or more uplink messages overlaps in time with at least one repetition of the downlink message. In some examples, the signaling that schedules the one or more uplink messages may be RRC signaling associated with semi-static scheduling. In some examples, the one or more uplink messages may be one or more of a PUCCH message, a PUSCH message, an SRS message, or a PRACH message.

At 420, the UE 115, the network entity 105, or both may operate in accordance with an SBFD collision resolution procedure (e.g., SBFD collision resolution procedure 300-a, as described with reference to FIG. 3A).

At 425, the UE 115 and the network entity 105 may perform SBFD communications in accordance with an outcome of the SBFD collision resolution procedure. For example, the UE 115 and the network entity 105 may communicate, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline (e.g., transmission timeline 340, as described with reference to FIG. 3A) relative to the first time.

In some examples, the UE 115 may receive, during each SBFD slot of a set of SBFD slots, the repetition of the downlink message based on the respective priority associated with each repetition of the downlink message being greater than the respective priority of each of the one or more uplink messages. Additionally, the UE 115 may drop, during each SBFD slot of the set of SBFD slots, the one or more uplink messages based on the respective priority associated with each repetition of the downlink message being greater than the respective priority of each of the one or more uplink messages.

In some examples, the downlink message is associated with a first subset of repetitions across a first subset of SBFD slots of the set of SBFD slots and associated with a second subset of repetitions across a second subset of SBFD slots of the set of SBFD slots, where the second subset of SBFD slots are subsequent to the first subset of SBFD slots.

In some examples, the first subset of repetitions is associated with a first priority that is greater than the respective priority of the one or more uplink messages. As such, the UE 115 may receive during the first subset of SBFD slots the first subset of repetitions of the downlink message based on the first subset of repetitions being associated with the first priority.

Additionally, or alternatively, the UE 115 may transmit an uplink message of the one or more uplink messages based on the uplink message being scheduled for transmission during an SBFD slot of the second subset of SBFD slots and based on the uplink message being a random access message (e.g., a PRACH message).

Additionally, or alternatively, the second subset of repetitions is associated with a first PHY priority. As such, the UE 115 may transmit an uplink message of the one or more uplink messages based on the uplink message being scheduled for transmission during an SBFD slot of the second subset of SBFD slots and based on the uplink message being associated with a second PHY priority that is greater than the first physical layer priority.

In some examples, the one or more SBFD slots includes a single SBFD slot scheduled with a downlink message via the control information and scheduled with an uplink message via the signaling. In some examples, a first portion of the uplink message spans a first subset of symbols of the single SBFD slot that is within the transmission timeline (e.g., transmission timeline 340, as described with reference to FIG. 3A). Additionally, or alternatively, a second portion of the uplink message spans a second subset of symbols of the single SBFD slot that is subsequent to the transmission timeline.

In some examples, the UE 115 may be configured with the cancellation capability to partially cancel messages scheduled for SBFD symbols. As such, the UE 115 may transmit the first portion of the uplink message and the second portion of the uplink message based on refraining from indicating the cancellation capability to the network entity 105.

In some examples, the UE 115 may transmit the first portion of the uplink message based on the first portion of the uplink message spanning the first subset of symbols within the transmission timeline and may cancel the second portion of the uplink message spanning the second subset of symbol subsequent to the transmission timeline based on transmitting the cancellation capability to the network entity 105.

In some examples, the UE 115 is not configured with a cancellation capability to partially cancel messages scheduled for SBFD symbols. As such, the UE 115 may transmit the first portion of the uplink message and the second portion of the uplink message based on not being configured with the cancellation capability.

In some examples, the UE 115 may transmit the first portion of the uplink message based on the first portion of the uplink message spanning the first subset of symbols within the transmission timeline and based on the uplink message being an SRS message.

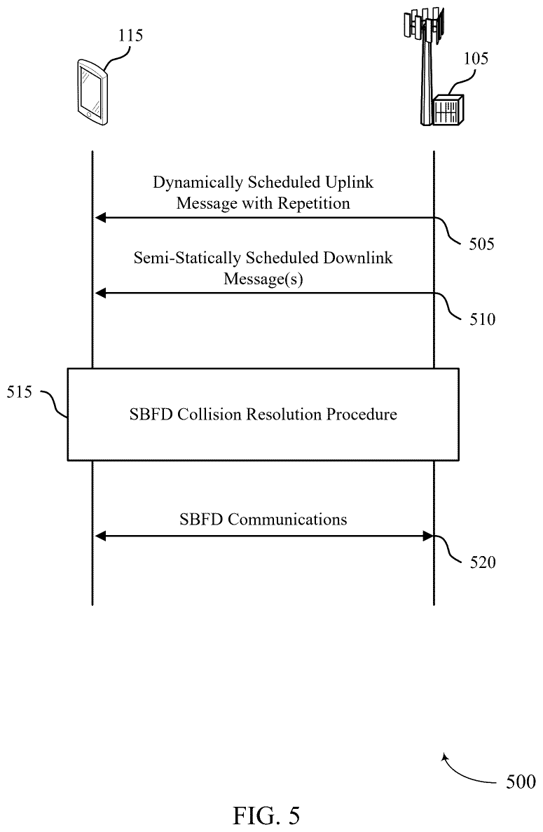

FIG. 5 shows an example of a process flow 500 that supports techniques for collision handling between semi-static and dynamic scheduling in accordance with one or more aspects of the present disclosure. In some examples, process flow 500 may implement aspects of wireless communications system 100, wireless communications system 200, SBFD collision resolution procedure 300-b, and SBFD collision resolution procedure 300-b. Process flow 500 may include a UE 115 which may be an example of a UE 115 as described with reference to FIGS. 1 through 3. Additionally, process flow 500 may include a network entity 105 which may be an example of a network entity 105 or a network entity 105, as described with reference to FIGS. 1 through 3. Alternative examples of the following may be implemented, where some steps are performed in a different order than described or are not performed at all. In some cases, steps may include additional features not mentioned below, or further steps may be added. In addition, it is understood that these processes may occur between any quantity of network devices and network device types.

At 505, the UE 115 may receive control information that schedules the UE 115 to transmit an uplink message that is associated with repetition across one or more SBFD slots. In some examples, the control information is a DCI associated with dynamic scheduling (e.g., DCI 315-b, as described with reference to FIG. 3B). In some examples, the uplink message is a PUCCH message, a PUSCH message, n SRS message, or a PRACH message.

At 510, the UE 115 may receive signaling that schedules the UE 115 to receive one or more downlink messages across the one or more SBFD slots, where at least one of the one or more downlink messages overlaps in time with at least one repetition of the uplink message. In some examples, the signaling is RRC signaling associated with semi-static scheduling. In some examples, the one or more downlink messages are one or more of a PDSCH message, a PDCCH message, or a CSI-RS message.

At 515, the UE 115, the network entity 105, or both may operate in accordance with an SBFD collision resolution procedure (e.g., SBFD collision resolution procedure 300-b, 300-c, or both, as described with reference to FIGS. 3B and 3C).

At 520, the UE 115 and the network entity 105 may perform SBFD communications in accordance with an outcome of the SBFD collision resolution procedure. For example, the UE 115 and the network entity 105 may communicate, during each SBFD slot of the one or more SBFD slots, a repetition of the uplink message or a downlink message of the one or more downlink messages based on a respective priority associated with each repetition of the uplink message and each of the one or more downlink messages.

In some examples, the UE 115 may transmit, during each SBFD slot of the set of SBFD slots, the repetition of the uplink message based on the respective priority associated with each repetition of the uplink message being greater than the respective priority of each of the one or more downlink messages. Additionally, the UE 115 may drop during each SBFD slot of the set of SBFD slots the one or more downlink messages based on the respective priority associated with each repetition of the uplink message being greater than the respective priority of each of the one or more uplink messages.

In some examples, the uplink message is associated with a first subset of repetitions across a first subset of SBFD slots of the set of SBFD slots and associated with a second subset of repetitions across a second subset of SBFD slots of the set of SBFD slots, where the second subset of SBFD slots are subsequent to the first subset of SBFD slots.

In some examples, the first subset of repetitions is associated with a first priority that is greater than the respective priority of the one or more downlink messages. As such, the UE 115 may transmit, during the first subset of SBFD slots, the first subset of repetitions of the uplink message based on the first subset of repetitions being associated with the first priority.

In some examples, the UE 115 may receive a downlink message of the one or more downlink messages based on the downlink message being scheduled for transmission during a SBFD slot of the second subset of SBFD slots and based on the downlink message being a PDCCH message.

In some examples, the second subset of repetitions may be associated with a first PHY priority. As such, the UE 115 may receive a downlink message of the one or more downlink messages based on the downlink message being scheduled for transmission during a SBFD slot of the second subset of SBFD slots and based on the downlink message being associated with a second PHY priority that is greater than the first physical layer priority.

In some cases, a first SBFD slot of the one or more SBFD slots is scheduled with a physical uplink message in an uplink subband and scheduled with an SPS-PDSCH message in a downlink subband. In some examples, the UE 115 may determine to transmit the physical uplink message based on a first priority associated with the physical uplink message being greater than a second priority associated with the SPS-PDSCH message.

Additionally, or alternatively, a second SBFD slot of the one or more SBFD slots may be scheduled for the UE 115 to transmit a feedback message associated with the SPS-PDSCH message. In some examples, the UE 115 may drop the feedback message based on dropping the SPS-PDSCH message. In some examples, the UE 115 may transmit the feedback message as a NACK message based on dropping the SPS-PDSCH message.

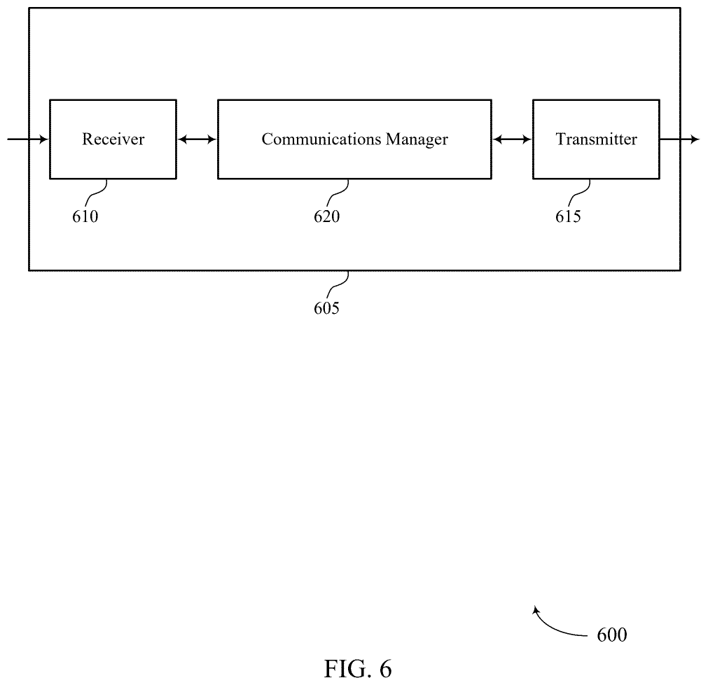

FIG. 6 shows a block diagram 600 of a device 605 that supports techniques for collision handling between semi-static and dynamic scheduling in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for collision handling between semi-static and dynamic scheduling). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for collision handling between semi-static and dynamic scheduling). In some examples, the transmitter 615 may be co-located with a receiver 610 in a transceiver component. The transmitter 615 may utilize a single antenna or a set of multiple antennas.

The communications manager 620, the receiver 610, the transmitter 615, or various combinations or components thereof may be examples of means for performing various aspects of techniques for collision handling between semi-static and dynamic scheduling as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

For example, the communications manager 620 is capable of, configured to, or operable to support a means for receiving, at a first time, control information that schedules the UE to receive a downlink message that is associated with repetition across one or more full duplex slots. The communications manager 620 is capable of, configured to, or operable to support a means for receiving signaling that schedules the UE to transmit one or more uplink messages across the one or more full duplex slots, where at least one of the one or more uplink messages overlaps in time with at least one repetition of the downlink message. The communications manager 620 is capable of, configured to, or operable to support a means for communicating, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time.

For example, the communications manager 620 is capable of, configured to, or operable to support a means for receiving control information that schedules the UE to transmit an uplink message that is associated with repetition across one or more full duplex slots. The communications manager 620 is capable of, configured to, or operable to support a means for receiving signaling that schedules the UE to receive one or more downlink messages across the one or more full duplex slots, where at least one of the one or more downlink messages overlaps in time with at least one repetition of the uplink message. The communications manager 620 is capable of, configured to, or operable to support a means for communicating, during each full duplex slot of the one or more full duplex slots, a repetition of the uplink message or a downlink message of the one or more downlink messages based on a respective priority associated with each repetition of the uplink message and each of the one or more downlink messages.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources.

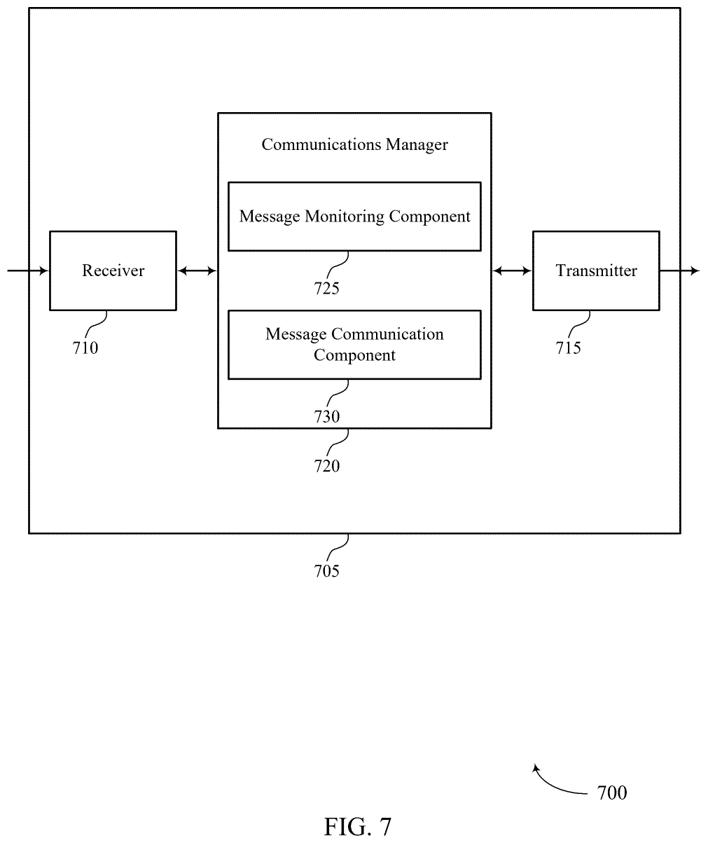

FIG. 7 shows a block diagram 700 of a device 705 that supports techniques for collision handling between semi-static and dynamic scheduling in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for collision handling between semi-static and dynamic scheduling). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for collision handling between semi-static and dynamic scheduling). In some examples, the transmitter 715 may be co-located with a receiver 710 in a transceiver component. The transmitter 715 may utilize a single antenna or a set of multiple antennas.

The device 705, or various components thereof, may be an example of means for performing various aspects of techniques for collision handling between semi-static and dynamic scheduling as described herein. For example, the communications manager 720 may include a message monitoring component 725 a message communication component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The message monitoring component 725 is capable of, configured to, or operable to support a means for receiving, at a first time, control information that schedules the UE to receive a downlink message that is associated with repetition across one or more full duplex slots. The message monitoring component 725 is capable of, configured to, or operable to support a means for receiving signaling that schedules the UE to transmit one or more uplink messages across the one or more full duplex slots, where at least one of the one or more uplink messages overlaps in time with at least one repetition of the downlink message. The message communication component 730 is capable of, configured to, or operable to support a means for communicating, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time.

The message monitoring component 725 is capable of, configured to, or operable to support a means for receiving control information that schedules the UE to transmit an uplink message that is associated with repetition across one or more full duplex slots. The message monitoring component 725 is capable of, configured to, or operable to support a means for receiving signaling that schedules the UE to receive one or more downlink messages across the one or more full duplex slots, where at least one of the one or more downlink messages overlaps in time with at least one repetition of the uplink message. The message communication component 730 is capable of, configured to, or operable to support a means for communicating, during each full duplex slot of the one or more full duplex slots, a repetition of the uplink message or a downlink message of the one or more downlink messages based on a respective priority associated with each repetition of the uplink message and each of the one or more downlink messages.

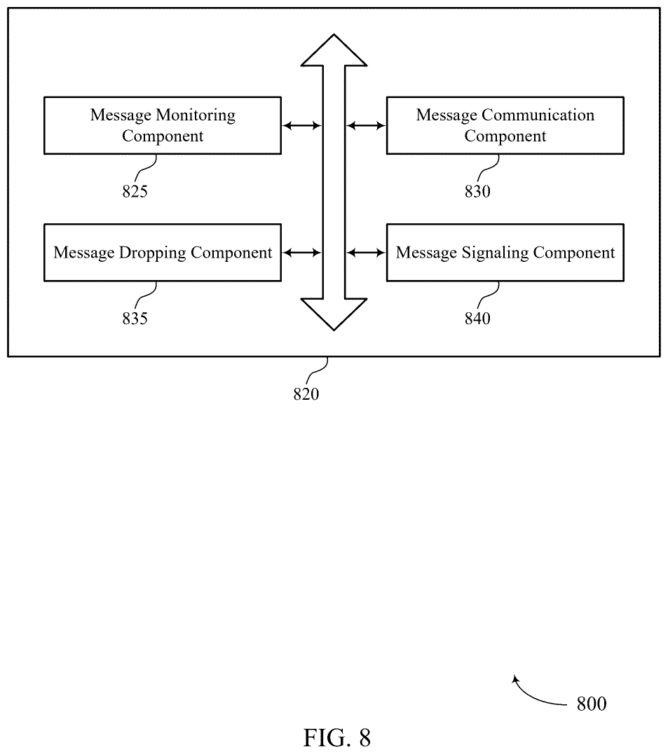

FIG. 8 shows a block diagram 800 of a communications manager 820 that supports techniques for collision handling between semi-static and dynamic scheduling in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for collision handling between semi-static and dynamic scheduling as described herein. For example, the communications manager 820 may include a message monitoring component 825, a message communication component 830, a message dropping component 835, a message signaling component 840, or any combination thereof. Each of these components, or components or subcomponents thereof (e.g., one or more processors, one or more memories), may communicate, directly or indirectly, with one another (e.g., via one or more buses).

The message monitoring component 825 is capable of, configured to, or operable to support a means for receiving, at a first time, control information that schedules the UE to receive a downlink message that is associated with repetition across one or more full duplex slots. In some examples, the message monitoring component 825 is capable of, configured to, or operable to support a means for receiving signaling that schedules the UE to transmit one or more uplink messages across the one or more full duplex slots, where at least one of the one or more uplink messages overlaps in time with at least one repetition of the downlink message. The message communication component 830 is capable of, configured to, or operable to support a means for communicating, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time.

In some examples, the one or more full duplex slots includes a set of multiple full duplex slots, and the message monitoring component 825 is capable of, configured to, or operable to support a means for receiving, during each full duplex slot of the set of multiple full duplex slots, the repetition of the downlink message based on the respective priority associated with each repetition of the downlink message being greater than the respective priority of each of the one or more uplink messages. In some examples, the one or more full duplex slots includes a set of multiple full duplex slots, and the message dropping component 835 is capable of, configured to, or operable to support a means for dropping, during each full duplex slot of the set of multiple full duplex slots, the one or more uplink messages based on the respective priority associated with each repetition of the downlink message being greater than the respective priority of each of the one or more uplink messages.

In some examples, the one or more full duplex slots includes a set of multiple full duplex slots. In some examples, the downlink message is associated with a first subset of repetitions across a first subset of full duplex slots of the set of multiple full duplex slots. In some examples, the downlink message is associated with a second subset of repetitions across a second subset of full duplex slots of the set of multiple full duplex slots. In some examples, the second subset of full duplex slots are subsequent to the first subset of full duplex slots.

In some examples, the first subset of repetitions is associated with a first priority that is greater than the respective priority of the one or more uplink messages, and the message monitoring component 825 is capable of, configured to, or operable to support a means for receiving, during the first subset of full duplex slots, the first subset of repetitions of the downlink message based on the first subset of repetitions being associated with the first priority.

In some examples, the message signaling component 840 is capable of, configured to, or operable to support a means for transmitting an uplink message of the one or more uplink messages based on the uplink message being scheduled for transmission during a full duplex slot of the second subset of full duplex slots and based on the uplink message being a random access message.

In some examples, the second subset of repetitions is associated with a first physical layer priority, and the message signaling component 840 is capable of, configured to, or operable to support a means for transmitting an uplink message of the one or more uplink messages based on the uplink message being scheduled for transmission during a full duplex slot of the second subset of full duplex slots and based on the uplink message being associated with a second physical layer priority that is greater than the first physical layer priority.

In some examples, the one or more full duplex slots includes a single full duplex slot scheduled with a downlink message via the control information and scheduled with an uplink message via the signaling. In some examples, a first portion of the uplink message spans a first subset of symbols of the single full duplex slot that is within the transmission timeline. In some examples, a second portion of the uplink message spans a second subset of symbols of the single full duplex slot that is subsequent to the transmission timeline.

In some examples, the UE is configured with a cancellation capability to partially cancel messages scheduled for full duplex symbols, and the message signaling component 840 is capable of, configured to, or operable to support a means for transmitting the first portion of the uplink message and the second portion of the uplink message based on refraining from indicating the cancellation capability to a network entity.

In some examples, the message signaling component 840 is capable of, configured to, or operable to support a means for transmitting, to a network entity, an indication that the UE is configured with a cancellation capability to partially cancel messages scheduled for full duplex symbols. In some examples, the message signaling component 840 is capable of, configured to, or operable to support a means for transmitting the first portion of the uplink message based on the first portion of the uplink message spanning the first subset of symbols within the transmission timeline and based on transmitting the cancellation capability.

In some examples, the UE is not configured with a cancellation capability to partially cancel messages scheduled for full duplex symbols, and the message signaling component 840 is capable of, configured to, or operable to support a means for transmitting the first portion of the uplink message and the second portion of the uplink message based on not being configured with the cancellation capability.

In some examples, the message signaling component 840 is capable of, configured to, or operable to support a means for transmitting the first portion of the uplink message based on the first portion of the uplink message spanning the first subset of symbols within the transmission timeline and based on the uplink message being a SRS.

In some examples, the control information is DCI associated with dynamic scheduling, the signaling is RRC signaling associated with semi-static scheduling, the downlink message is a PDSCH or a CSI-RS, and the one or more uplink messages are one or more of a PUCCH, a PUSCH, a SRS, or a PRACH.

In some examples, the message monitoring component 825 is capable of, configured to, or operable to support a means for receiving control information that schedules the UE to transmit an uplink message that is associated with repetition across one or more full duplex slots. In some examples, the message monitoring component 825 is capable of, configured to, or operable to support a means for receiving signaling that schedules the UE to receive one or more downlink messages across the one or more full duplex slots, where at least one of the one or more downlink messages overlaps in time with at least one repetition of the uplink message. In some examples, the message communication component 830 is capable of, configured to, or operable to support a means for communicating, during each full duplex slot of the one or more full duplex slots, a repetition of the uplink message or a downlink message of the one or more downlink messages based on a respective priority associated with each repetition of the uplink message and each of the one or more downlink messages.

In some examples, the one or more full duplex slots includes a set of multiple full duplex slots, and the message signaling component 840 is capable of, configured to, or operable to support a means for transmitting, during each full duplex slot of the set of multiple full duplex slots, the repetition of the uplink message based on the respective priority associated with each repetition of the uplink message being greater than the respective priority of each of the one or more downlink messages. In some examples, the one or more full duplex slots includes a set of multiple full duplex slots, and the message dropping component 835 is capable of, configured to, or operable to support a means for dropping, during each full duplex slot of the set of multiple full duplex slots, the one or more downlink messages based on the respective priority associated with each repetition of the uplink message being greater than the respective priority of each of the one or more downlink messages.

In some examples, the one or more full duplex slots includes a set of multiple full duplex slots. In some examples, the uplink message is associated with a first subset of repetitions across a first subset of full duplex slots of the set of multiple full duplex slots. In some examples, the uplink message is associated with a second subset of repetitions across a second subset of full duplex slots of the set of multiple full duplex slots. In some examples, the second subset of full duplex slots are subsequent to the first subset of full duplex slots.

In some examples, the first subset of repetitions is associated with a first priority that is greater than the respective priority of the one or more downlink messages, and the message signaling component 840 is capable of, configured to, or operable to support a means for transmitting, during the first subset of full duplex slots, the first subset of repetitions of the uplink message based on the first subset of repetitions being associated with the first priority.

In some examples, the message monitoring component 825 is capable of, configured to, or operable to support a means for receiving a downlink message of the one or more downlink messages based on the downlink message being scheduled for transmission during a full duplex slot of the second subset of full duplex slots and based on the downlink message being a physical downlink control channel message.

In some examples, the second subset of repetitions is associated with a first physical layer priority, and the message monitoring component 825 is capable of, configured to, or operable to support a means for receiving a downlink message of the one or more downlink messages based on the downlink message being scheduled for transmission during a full duplex slot of the second subset of full duplex slots and based on the downlink message being associated with a second physical layer priority that is greater than the first physical layer priority.

In some examples, a first full duplex slot of the one or more full duplex slots is scheduled with a physical uplink message and scheduled with a semi-persistent scheduling physical downlink message, and the message signaling component 840 is capable of, configured to, or operable to support a means for transmitting the physical uplink message based on a first priority associated with the physical uplink message being greater than a second priority associated with the semi-persistent scheduling physical downlink message.

In some examples, a second full duplex slot of the one or more full duplex slots is scheduled for the UE to transmit a feedback message associated with the semi-persistent scheduling physical downlink message.

In some examples, the message dropping component 835 is capable of, configured to, or operable to support a means for dropping the feedback message based on dropping the semi-persistent scheduling physical downlink message.

In some examples, the message signaling component 840 is capable of, configured to, or operable to support a means for transmitting the feedback message as a negative acknowledgement message based on dropping the semi-persistent scheduling physical downlink message.

In some examples, the control information is DCI associated with dynamic scheduling, the signaling is RRC signaling associated with semi-static scheduling, the uplink message is a PUCCH, a PUSCH, a SRS, or a PRACH, and the one or more downlink messages are one or more of a PDSCH, a physical downlink controller channel, or a CSI-RS.

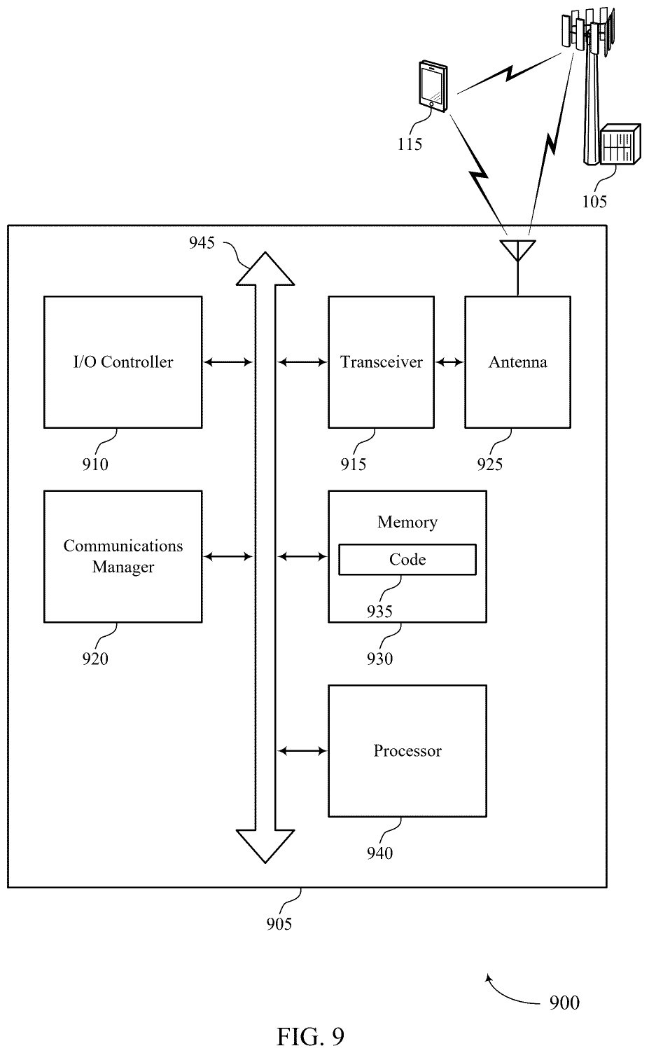

FIG. 9 shows a diagram of a system 900 including a device 905 that supports techniques for collision handling between semi-static and dynamic scheduling in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting techniques for collision handling between semi-static and dynamic scheduling). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

For example, the communications manager 920 is capable of, configured to, or operable to support a means for receiving, at a first time, control information that schedules the UE to receive a downlink message that is associated with repetition across one or more full duplex slots. The communications manager 920 is capable of, configured to, or operable to support a means for receiving signaling that schedules the UE to transmit one or more uplink messages across the one or more full duplex slots, where at least one of the one or more uplink messages overlaps in time with at least one repetition of the downlink message. The communications manager 920 is capable of, configured to, or operable to support a means for communicating, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time.

For example, the communications manager 920 is capable of, configured to, or operable to support a means for receiving control information that schedules the UE to transmit an uplink message that is associated with repetition across one or more full duplex slots. The communications manager 920 is capable of, configured to, or operable to support a means for receiving signaling that schedules the UE to receive one or more downlink messages across the one or more full duplex slots, where at least one of the one or more downlink messages overlaps in time with at least one repetition of the uplink message. The communications manager 920 is capable of, configured to, or operable to support a means for communicating, during each full duplex slot of the one or more full duplex slots, a repetition of the uplink message or a downlink message of the one or more downlink messages based on a respective priority associated with each repetition of the uplink message and each of the one or more downlink messages.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of techniques for collision handling between semi-static and dynamic scheduling as described herein, or the at least one processor 940 and the at least one memory 930 may be otherwise configured to, individually or collectively, perform or support such operations.

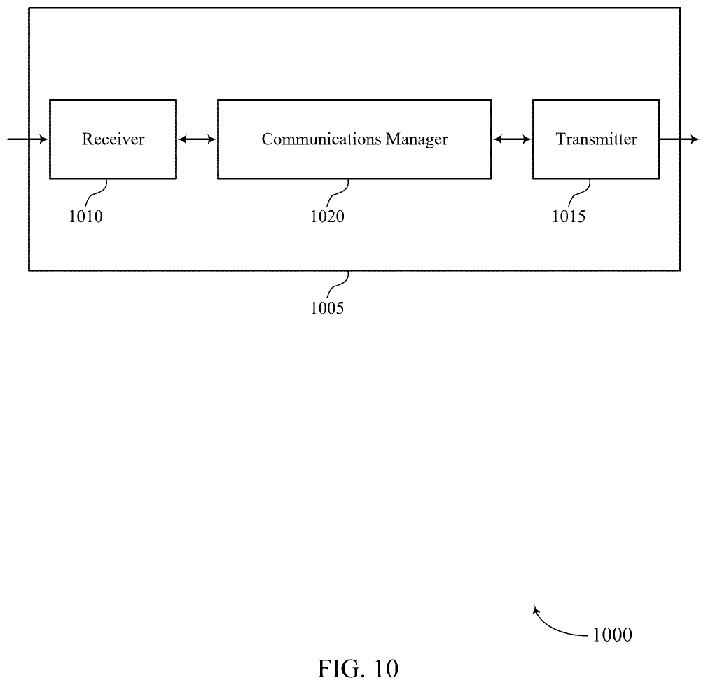

FIG. 10 shows a block diagram 1000 of a device 1005 that supports techniques for collision handling between semi-static and dynamic scheduling in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of techniques for collision handling between semi-static and dynamic scheduling as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

For example, the communications manager 1020 is capable of, configured to, or operable to support a means for outputting, at a first time, control information that schedules a UE to receive a downlink message that is associated with repetition across one or more full duplex slots. The communications manager 1020 is capable of, configured to, or operable to support a means for outputting signaling that schedules the UE to transmit one or more uplink messages across the one or more full duplex slots, where at least one uplink message of the one or more uplink messages overlaps in time with at least one repetition of the downlink message. The communications manager 1020 is capable of, configured to, or operable to support a means for communicating, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time.

For example, the communications manager 1020 is capable of, configured to, or operable to support a means for outputting control information that schedules a UE to transmit an uplink message that is associated with repetition across one or more full duplex slots. The communications manager 1020 is capable of, configured to, or operable to support a means for outputting signaling that schedules the UE to receive one or more downlink messages across the one or more full duplex slots, where at least one of the one or more downlink messages overlaps in time with at least one repetition of the uplink message. The communications manager 1020 is capable of, configured to, or operable to support a means for communicating, during each full duplex slot of the one or more full duplex slots, a repetition of the uplink message or a downlink message of the one or more downlink messages based on a respective priority associated with each repetition of the uplink message and each of the one or more downlink messages.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources.

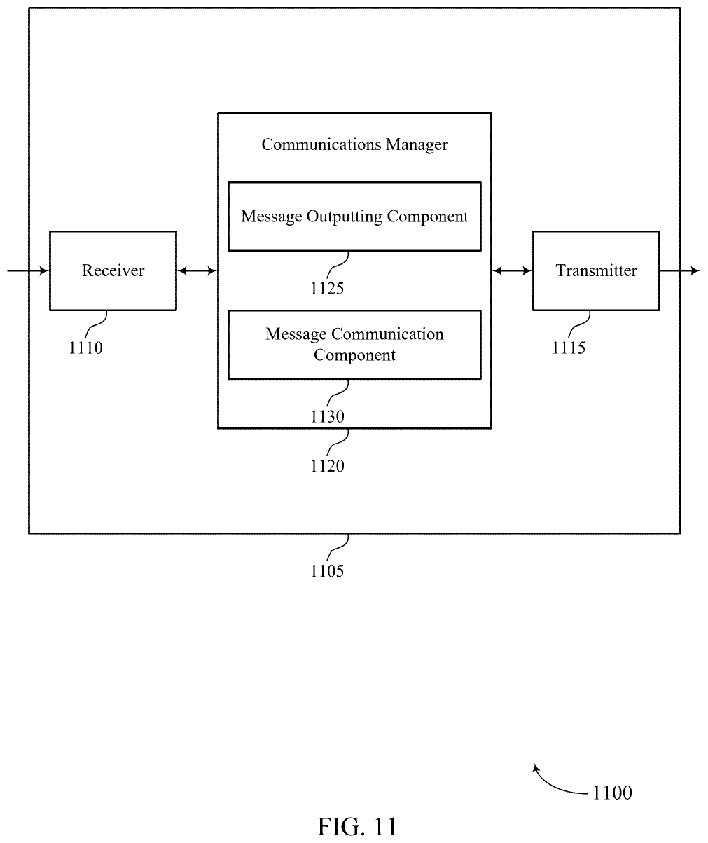

FIG. 11 shows a block diagram 1100 of a device 1105 that supports techniques for collision handling between semi-static and dynamic scheduling in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for collision handling between semi-static and dynamic scheduling as described herein. For example, the communications manager 1120 may include a message outputting component 1125 a message communication component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The message outputting component 1125 is capable of, configured to, or operable to support a means for outputting, at a first time, control information that schedules a UE to receive a downlink message that is associated with repetition across one or more full duplex slots. The message outputting component 1125 is capable of, configured to, or operable to support a means for outputting signaling that schedules the UE to transmit one or more uplink messages across the one or more full duplex slots, where at least one uplink message of the one or more uplink messages overlaps in time with at least one repetition of the downlink message. The message communication component 1130 is capable of, configured to, or operable to support a means for communicating, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time.

The message outputting component 1125 is capable of, configured to, or operable to support a means for outputting control information that schedules a UE to transmit an uplink message that is associated with repetition across one or more full duplex slots. The message outputting component 1125 is capable of, configured to, or operable to support a means for outputting signaling that schedules the UE to receive one or more downlink messages across the one or more full duplex slots, where at least one of the one or more downlink messages overlaps in time with at least one repetition of the uplink message. The message communication component 1130 is capable of, configured to, or operable to support a means for communicating, during each full duplex slot of the one or more full duplex slots, a repetition of the uplink message or a downlink message of the one or more downlink messages based on a respective priority associated with each repetition of the uplink message and each of the one or more downlink messages.

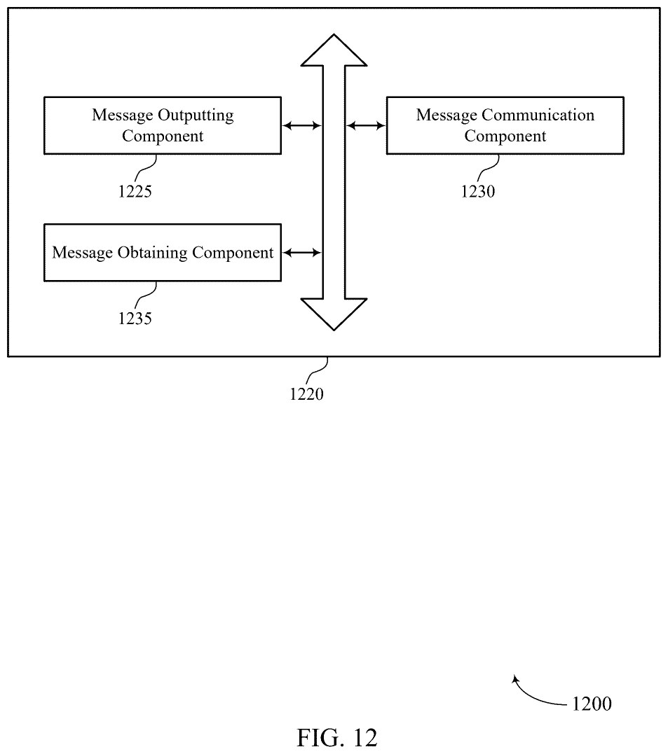

FIG. 12 shows a block diagram 1200 of a communications manager 1220 that supports techniques for collision handling between semi-static and dynamic scheduling in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for collision handling between semi-static and dynamic scheduling as described herein. For example, the communications manager 1220 may include a message outputting component 1225, a message communication component 1230, a message obtaining component 1235, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The message outputting component 1225 is capable of, configured to, or operable to support a means for outputting, at a first time, control information that schedules a UE to receive a downlink message that is associated with repetition across one or more full duplex slots. In some examples, the message outputting component 1225 is capable of, configured to, or operable to support a means for outputting signaling that schedules the UE to transmit one or more uplink messages across the one or more full duplex slots, where at least one uplink message of the one or more uplink messages overlaps in time with at least one repetition of the downlink message. The message communication component 1230 is capable of, configured to, or operable to support a means for communicating, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time.

In some examples, the one or more full duplex slots includes a set of multiple full duplex slots, and the message outputting component 1225 is capable of, configured to, or operable to support a means for outputting, during each full duplex slot of the set of multiple full duplex slots, the repetition of the downlink message based on the respective priority associated with each repetition of the downlink message being greater than the respective priority of each of the one or more uplink messages.

In some examples, the one or more full duplex slots includes a set of multiple full duplex slots. In some examples, the downlink message is associated with a first subset of repetitions across a first subset of full duplex slots of the set of multiple full duplex slots. In some examples, the downlink message is associated with a second subset of repetitions across a second subset of full duplex slots of the set of multiple full duplex slots. In some examples, the second subset of full duplex slots are subsequent to the first subset of full duplex slots.

In some examples, the first subset of repetitions is associated with a first priority that is greater than the respective priority of the one or more uplink messages, and the message outputting component 1225 is capable of, configured to, or operable to support a means for outputting, during the first subset of full duplex slots, the first subset of repetitions of the downlink message based on the first subset of repetitions being associated with the first priority.

In some examples, the message obtaining component 1235 is capable of, configured to, or operable to support a means for obtaining an uplink message of the one or more uplink messages based on the uplink message being scheduled for transmission during a full duplex slot of the second subset of full duplex slots and based on the uplink message being a random access message.

In some examples, the second subset of repetitions is associated with a first physical layer priority, and the message obtaining component 1235 is capable of, configured to, or operable to support a means for obtaining an uplink message of the one or more uplink messages based on the uplink message being scheduled for transmission during a full duplex slot of the second subset of full duplex slots and based on the uplink message being associated with a second physical layer priority that is greater than the first physical layer priority.

In some examples, the one or more full duplex slots includes a single full duplex slot scheduled with a downlink message via the control information and scheduled with an uplink message via the signaling. In some examples, a first portion of the uplink message spans a first subset of symbols of the single full duplex slot that is within the transmission timeline. In some examples, a second portion of the uplink message spans a second subset of symbols of the single full duplex slot that is subsequent to the transmission timeline.

In some examples, the message obtaining component 1235 is capable of, configured to, or operable to support a means for obtaining, from the UE, an indication that the UE is configured with a cancellation capability to partially cancel messages scheduled for full duplex symbols. In some examples, the message obtaining component 1235 is capable of, configured to, or operable to support a means for obtaining the first portion of the uplink message based on the first portion of the uplink message spanning the first subset of symbols within the transmission timeline and based on obtaining the cancellation capability.

In some examples, the message obtaining component 1235 is capable of, configured to, or operable to support a means for obtaining the first portion of the uplink message based on the first portion of the uplink message spanning the first subset of symbols within the transmission timeline and based on the uplink message being a SRS.

In some examples, the control information is DCI associated with dynamic scheduling, the signaling is RRC signaling associated with semi-static scheduling, the downlink message is a PDSCH or a CSI-RS, and the one or more uplink messages are one or more of a PUCCH, a PUSCH, a SRS, or a PRACH.

In some examples, the message outputting component 1225 is capable of, configured to, or operable to support a means for outputting control information that schedules a UE to transmit an uplink message that is associated with repetition across one or more full duplex slots. In some examples, the message outputting component 1225 is capable of, configured to, or operable to support a means for outputting signaling that schedules the UE to receive one or more downlink messages across the one or more full duplex slots, where at least one of the one or more downlink messages overlaps in time with at least one repetition of the uplink message. In some examples, the message communication component 1230 is capable of, configured to, or operable to support a means for communicating, during each full duplex slot of the one or more full duplex slots, a repetition of the uplink message or a downlink message of the one or more downlink messages based on a respective priority associated with each repetition of the uplink message and each of the one or more downlink messages.

In some examples, the one or more full duplex slots includes a set of multiple full duplex slots, and the message obtaining component 1235 is capable of, configured to, or operable to support a means for obtaining, during each full duplex slot of the set of multiple full duplex slots, the repetition of the uplink message based on the respective priority associated with each repetition of the uplink message being greater than the respective priority of each of the one or more downlink messages.

In some examples, the one or more full duplex slots includes a set of multiple full duplex slots. In some examples, the uplink message is associated with a first subset of repetitions across a first subset of full duplex slots of the set of multiple full duplex slots. In some examples, the uplink message is associated with a second subset of repetitions across a second subset of full duplex slots of the set of multiple full duplex slots. In some examples, the second subset of full duplex slots are subsequent to the first subset of full duplex slots.

In some examples, the first subset of repetitions is associated with a first priority that is greater than the respective priority of the one or more downlink messages, and the message obtaining component 1235 is capable of, configured to, or operable to support a means for obtaining, during the first subset of full duplex slots, the first subset of repetitions of the uplink message based on the first subset of repetitions being associated with the first priority.

In some examples, the message outputting component 1225 is capable of, configured to, or operable to support a means for outputting a downlink message of the one or more downlink messages based on the downlink message being scheduled for transmission during a full duplex slot of the second subset of full duplex slots and based on the downlink message being a physical downlink control channel message.

In some examples, the second subset of repetitions is associated with a first physical layer priority, and the message outputting component 1225 is capable of, configured to, or operable to support a means for outputting a downlink message of the one or more downlink messages based on the downlink message being scheduled for transmission during a full duplex slot of the second subset of full duplex slots and based on the downlink message being associated with a second physical layer priority that is greater than the first physical layer priority.

In some examples, a first full duplex slot of the one or more full duplex slots is scheduled with a physical uplink message and scheduled with a semi-persistent scheduling physical downlink message, and the message obtaining component 1235 is capable of, configured to, or operable to support a means for obtaining the physical uplink message based on a first priority associated with the physical uplink message being greater than a second priority associated with the semi-persistent scheduling physical downlink message.

In some examples, a second full duplex slot of the one or more full duplex slots is scheduled for the UE to transmit a feedback message associated with the semi-persistent scheduling physical downlink message.

In some examples, the message obtaining component 1235 is capable of, configured to, or operable to support a means for obtaining the feedback message as a negative acknowledgement message based on dropping the semi-persistent scheduling physical downlink message.

In some examples, the control information is DCI associated with dynamic scheduling, the signaling is RRC signaling associated with semi-static scheduling, the uplink message is a PUCCH, a PUSCH, a SRS, or a PRACH, and the one or more downlink messages are one or more of a PDSCH, a physical downlink controller channel, or a CSI-RS.

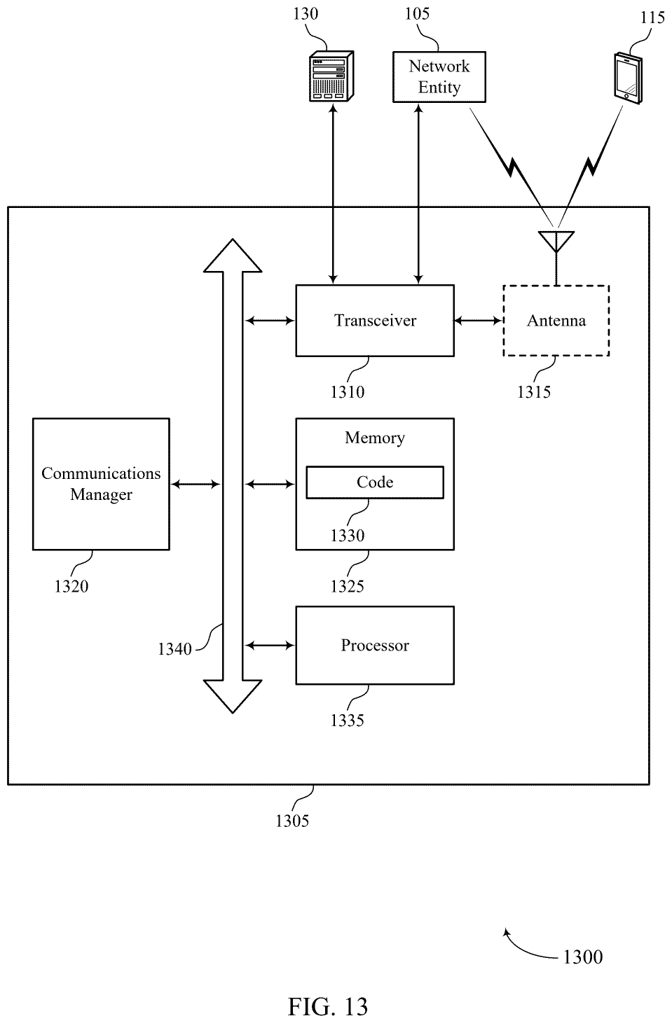

FIG. 13 shows a diagram of a system 1300 including a device 1305 that supports techniques for collision handling between semi-static and dynamic scheduling in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting techniques for collision handling between semi-static and dynamic scheduling). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

For example, the communications manager 1320 is capable of, configured to, or operable to support a means for outputting, at a first time, control information that schedules a UE to receive a downlink message that is associated with repetition across one or more full duplex slots. The communications manager 1320 is capable of, configured to, or operable to support a means for outputting signaling that schedules the UE to transmit one or more uplink messages across the one or more full duplex slots, where at least one uplink message of the one or more uplink messages overlaps in time with at least one repetition of the downlink message. The communications manager 1320 is capable of, configured to, or operable to support a means for communicating, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time.

For example, the communications manager 1320 is capable of, configured to, or operable to support a means for outputting control information that schedules a UE to transmit an uplink message that is associated with repetition across one or more full duplex slots. The communications manager 1320 is capable of, configured to, or operable to support a means for outputting signaling that schedules the UE to receive one or more downlink messages across the one or more full duplex slots, where at least one of the one or more downlink messages overlaps in time with at least one repetition of the uplink message. The communications manager 1320 is capable of, configured to, or operable to support a means for communicating, during each full duplex slot of the one or more full duplex slots, a repetition of the uplink message or a downlink message of the one or more downlink messages based on a respective priority associated with each repetition of the uplink message and each of the one or more downlink messages.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of techniques for collision handling between semi-static and dynamic scheduling as described herein, or the at least one processor 1335 and the at least one memory 1325 may be otherwise configured to, individually or collectively, perform or support such operations.

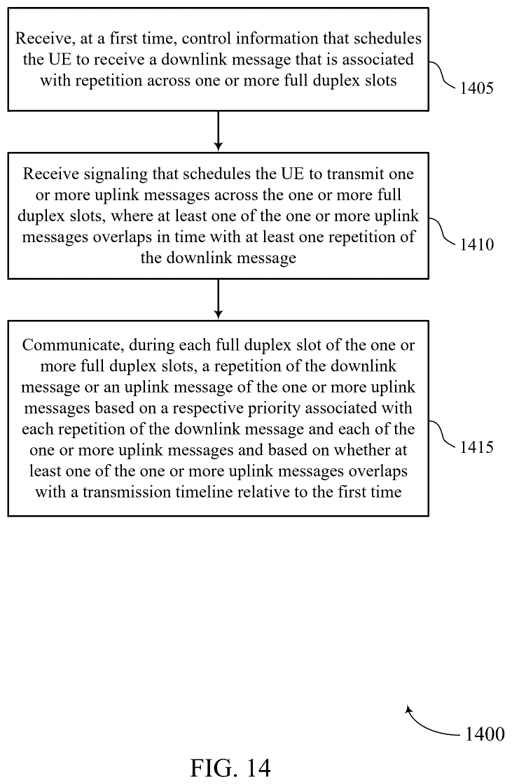

FIG. 14 shows a flowchart illustrating a method 1400 that supports techniques for collision handling between semi-static and dynamic scheduling in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, at a first time, control information that schedules the UE to receive a downlink message that is associated with repetition across one or more full duplex slots. The operations of 1405 may be performed in accordance with examples as disclosed herein. In some examples, aspects of the operations of 1405 may be performed by a message monitoring component 825 as described with reference to FIG. 8.

At 1410, the method may include receiving signaling that schedules the UE to transmit one or more uplink messages across the one or more full duplex slots, where at least one of the one or more uplink messages overlaps in time with at least one repetition of the downlink message. The operations of 1410 may be performed in accordance with examples as disclosed herein. In some examples, aspects of the operations of 1410 may be performed by a message monitoring component 825 as described with reference to FIG. 8.

At 1415, the method may include communicating, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time. The operations of 1415 may be performed in accordance with examples as disclosed herein. In some examples, aspects of the operations of 1415 may be performed by a message communication component 830 as described with reference to FIG. 8.

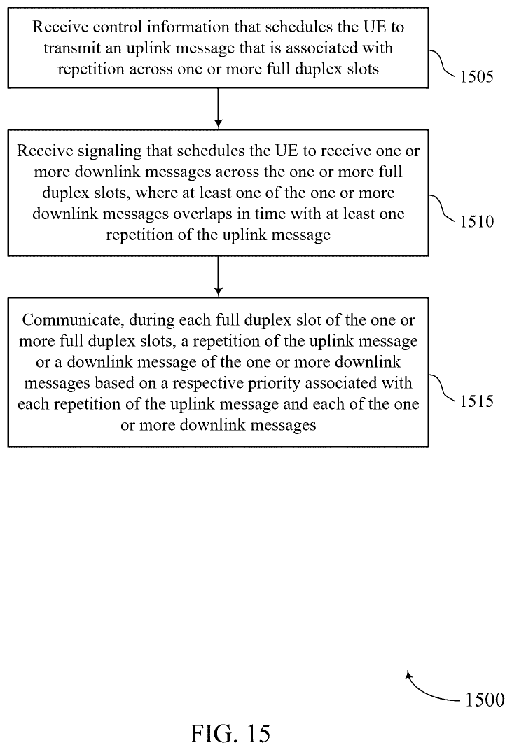

FIG. 15 shows a flowchart illustrating a method 1500 that supports techniques for collision handling between semi-static and dynamic scheduling in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving control information that schedules the UE to transmit an uplink message that is associated with repetition across one or more full duplex slots. The operations of 1505 may be performed in accordance with examples as disclosed herein. In some examples, aspects of the operations of 1505 may be performed by a message monitoring component 825 as described with reference to FIG. 8.

At 1510, the method may include receiving signaling that schedules the UE to receive one or more downlink messages across the one or more full duplex slots, where at least one of the one or more downlink messages overlaps in time with at least one repetition of the uplink message. The operations of 1510 may be performed in accordance with examples as disclosed herein. In some examples, aspects of the operations of 1510 may be performed by a message monitoring component 825 as described with reference to FIG. 8.

At 1515, the method may include communicating, during each full duplex slot of the one or more full duplex slots, a repetition of the uplink message or a downlink message of the one or more downlink messages based on a respective priority associated with each repetition of the uplink message and each of the one or more downlink messages. The operations of 1515 may be performed in accordance with examples as disclosed herein. In some examples, aspects of the operations of 1515 may be performed by a message communication component 830 as described with reference to FIG. 8.

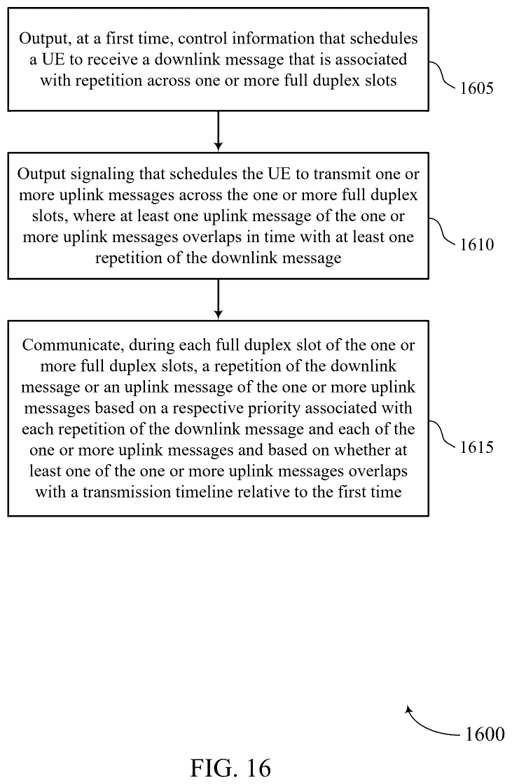

FIG. 16 shows a flowchart illustrating a method 1600 that supports techniques for collision handling between semi-static and dynamic scheduling in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include outputting, at a first time, control information that schedules a UE to receive a downlink message that is associated with repetition across one or more full duplex slots. The operations of 1605 may be performed in accordance with examples as disclosed herein. In some examples, aspects of the operations of 1605 may be performed by a message outputting component 1225 as described with reference to FIG. 12.

At 1610, the method may include outputting signaling that schedules the UE to transmit one or more uplink messages across the one or more full duplex slots, where at least one uplink message of the one or more uplink messages overlaps in time with at least one repetition of the downlink message. The operations of 1610 may be performed in accordance with examples as disclosed herein. In some examples, aspects of the operations of 1610 may be performed by a message outputting component 1225 as described with reference to FIG. 12.

At 1615, the method may include communicating, during each full duplex slot of the one or more full duplex slots, a repetition of the downlink message or an uplink message of the one or more uplink messages based on a respective priority associated with each repetition of the downlink message and each of the one or more uplink messages and based on whether at least one of the one or more uplink messages overlaps with a transmission timeline relative to the first time. The operations of 1615 may be performed in accordance with examples as disclosed herein. In some examples, aspects of the operations of 1615 may be performed by a message communication component 1230 as described with reference to FIG. 12.

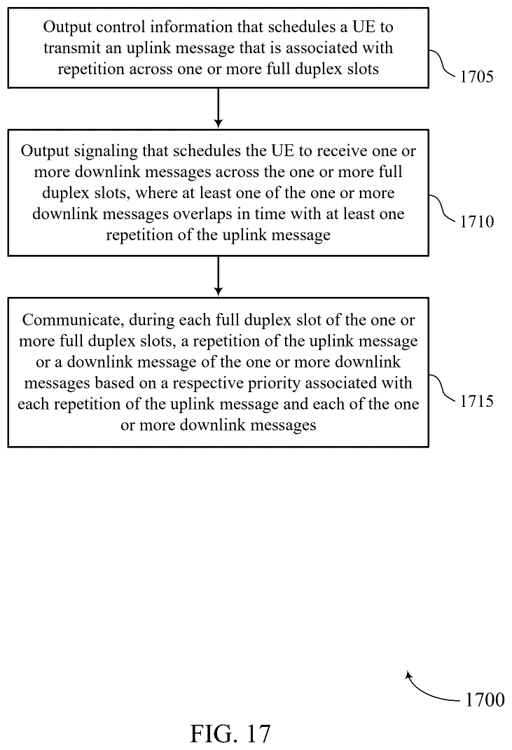

FIG. 17 shows a flowchart illustrating a method 1700 that supports techniques for collision handling between semi-static and dynamic scheduling in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting control information that schedules a UE to transmit an uplink message that is associated with repetition across one or more full duplex slots. The operations of 1705 may be performed in accordance with examples as disclosed herein. In some examples, aspects of the operations of 1705 may be performed by a message outputting component 1225 as described with reference to FIG. 12.

At 1710, the method may include outputting signaling that schedules the UE to receive one or more downlink messages across the one or more full duplex slots, where at least one of the one or more downlink messages overlaps in time with at least one repetition of the uplink message. The operations of 1710 may be performed in accordance with examples as disclosed herein. In some examples, aspects of the operations of 1710 may be performed by a message outputting component 1225 as described with reference to FIG. 12.

At 1715, the method may include communicating, during each full duplex slot of the one or more full duplex slots, a repetition of the uplink message or a downlink message of the one or more downlink messages based on a respective priority associated with each repetition of the uplink message and each of the one or more downlink messages. The operations of 1715 may be performed in accordance with examples as disclosed herein. In some examples, aspects of the operations of 1715 may be performed by a message communication component 1230 as described with reference to FIG. 12.

The following provides an overview of aspects of the present disclosure:

Aspect 1: A method, at a UE, comprising: receiving, at a first time, control information that schedules the UE to receive a downlink message that is associated with repetition across one or more full duplex slots; receiving signaling that schedules the UE to transmit one or more uplink messages across the one or more full duplex slots, wherein at least one of the one or more uplink messages overlaps in time with at least one repetition of the downlink message; and communicating, during each full duplex slot of the one or more full duplex slots, a repetition of the downlink message or an uplink message of the one or more uplink messages based at least in part on a respective priority associated with each repetition of the downlink message and each of the one or more uplink messages and based at least in part on whether at least one of the one or more uplink messages overlaps with a transmission timeline relative to the first time.

Aspect 2: The method of aspect 1, wherein the one or more full duplex slots includes a plurality of full duplex slots, the method further comprising: receiving, during each full duplex slot of the plurality of full duplex slots, the repetition of the downlink message based at least in part on the respective priority associated with each repetition of the downlink message being greater than the respective priority of each of the one or more uplink messages; and dropping, during each full duplex slot of the plurality of full duplex slots, the one or more uplink messages based at least in part on the respective priority associated with each repetition of the downlink message being greater than the respective priority of each of the one or more uplink messages.

Aspect 3: The method of any of aspects 1 through 2, wherein the one or more full duplex slots includes a plurality of full duplex slots, the downlink message is associated with a first subset of repetitions across a first subset of full duplex slots of the plurality of full duplex slots, the downlink message is associated with a second subset of repetitions across a second subset of full duplex slots of the plurality of full duplex slots, and the second subset of full duplex slots are subsequent to the first subset of full duplex slots.

Aspect 4: The method of aspect 3, wherein the first subset of repetitions is associated with a first priority that is greater than the respective priority of the one or more uplink messages, the method further comprising: receiving, during the first subset of full duplex slots, the first subset of repetitions of the downlink message based at least in part on the first subset of repetitions being associated with the first priority.

Aspect 5: The method of any of aspects 3 through 4, further comprising: transmitting an uplink message of the one or more uplink messages based at least in part on the uplink message being scheduled for transmission during a full duplex slot of the second subset of full duplex slots and based at least in part on the uplink message being a random access message.

Aspect 6: The method of any of aspects 3 through 5, wherein the second subset of repetitions is associated with a first physical layer priority, the method further comprising: transmitting an uplink message of the one or more uplink messages based at least in part on the uplink message being scheduled for transmission during a full duplex slot of the second subset of full duplex slots and based at least in part on the uplink message being associated with a second physical layer priority that is greater than the first physical layer priority.

Aspect 7: The method of any of aspects 1 through 6, wherein the one or more full duplex slots includes a single full duplex slot scheduled with a downlink message via the control information and scheduled with an uplink message via the signaling, a first portion of the uplink message spans a first subset of symbols of the single full duplex slot that is within the transmission timeline, and a second portion of the uplink message spans a second subset of symbols of the single full duplex slot that is subsequent to the transmission timeline.

Aspect 8: The method of aspect 7, wherein the UE is configured with a cancellation capability to partially cancel messages scheduled for full duplex symbols, the method further comprising: transmitting the first portion of the uplink message and the second portion of the uplink message based at least in part on refraining from indicating the cancellation capability to a network entity.

Aspect 9: The method of any of aspects 7 through 8, further comprising: transmitting, to a network entity, an indication that the UE is configured with a cancellation capability to partially cancel messages scheduled for full duplex symbols; and transmitting the first portion of the uplink message based at least in part on the first portion of the uplink message spanning the first subset of symbols within the transmission timeline and based at least in part on transmitting the cancellation capability.

Aspect 10: The method of any of aspects 7 through 9, wherein the UE is not configured with a cancellation capability to partially cancel messages scheduled for full duplex symbols, the method further comprising: transmitting the first portion of the uplink message and the second portion of the uplink message based at least in part on not being configured with the cancellation capability.

Aspect 11: The method of any of aspects 7 through 10, further comprising: transmitting the first portion of the uplink message based at least in part on the first portion of the uplink message spanning the first subset of symbols within the transmission timeline and based at least in part on the uplink message being a SRS.

Aspect 12: The method of any of aspects 1 through 11, wherein the control information is DCI associated with dynamic scheduling, the signaling is RRC signaling associated with semi-static scheduling, the downlink message is a PDSCH or a CSI-RS, and the one or more uplink messages are one or more of a PUCCH, a PUSCH, a SRS, or a PRACH.

Aspect 13: A method, at a UE, comprising: receiving control information that schedules the UE to transmit an uplink message that is associated with repetition across one or more full duplex slots; receiving signaling that schedules the UE to receive one or more downlink messages across the one or more full duplex slots, wherein at least one of the one or more downlink messages overlaps in time with at least one repetition of the uplink message; and communicating, during each full duplex slot of the one or more full duplex slots, a repetition of the uplink message or a downlink message of the one or more downlink messages based at least in part on a respective priority associated with each repetition of the uplink message and each of the one or more downlink messages.

Aspect 14: The method of aspect 13, wherein the one or more full duplex slots includes a plurality of full duplex slots, the method further comprising: transmitting, during each full duplex slot of the plurality of full duplex slots, the repetition of the uplink message based at least in part on the respective priority associated with each repetition of the uplink message being greater than the respective priority of each of the one or more downlink messages; and dropping, during each full duplex slot of the plurality of full duplex slots, the one or more downlink messages based at least in part on the respective priority associated with each repetition of the uplink message being greater than the respective priority of each of the one or more downlink messages.

Aspect 15: The method of any of aspects 13 through 14, wherein the one or more full duplex slots includes a plurality of full duplex slots, the uplink message is associated with a first subset of repetitions across a first subset of full duplex slots of the plurality of full duplex slots, the uplink message is associated with a second subset of repetitions across a second subset of full duplex slots of the plurality of full duplex slots, and the second subset of full duplex slots are subsequent to the first subset of full duplex slots.

Aspect 16: The method of aspect 15, wherein the first subset of repetitions is associated with a first priority that is greater than the respective priority of the one or more downlink messages, the method further comprising: transmitting, during the first subset of full duplex slots, the first subset of repetitions of the uplink message based at least in part on the first subset of repetitions being associated with the first priority.

Aspect 17: The method of any of aspects 15 through 16, further comprising: receiving a downlink message of the one or more downlink messages based at least in part on the downlink message being scheduled for transmission during a full duplex slot of the second subset of full duplex slots and based at least in part on the downlink message being a physical downlink control channel message.

Aspect 18: The method of any of aspects 15 through 17, wherein the second subset of repetitions is associated with a first physical layer priority, the method further comprising: receiving a downlink message of the one or more downlink messages based at least in part on the downlink message being scheduled for transmission during a full duplex slot of the second subset of full duplex slots and based at least in part on the downlink message being associated with a second physical layer priority that is greater than the first physical layer priority.

Aspect 19: The method of any of aspects 13 through 18, wherein a first full duplex slot of the one or more full duplex slots is scheduled with a physical uplink message and scheduled with a semi-persistent scheduling physical downlink message, the method further comprising: transmitting the physical uplink message based at least in part on a first priority associated with the physical uplink message being greater than a second priority associated with the semi-persistent scheduling physical downlink message.

Aspect 20: The method of aspect 19, wherein a second full duplex slot of the one or more full duplex slots is scheduled for the UE to transmit a feedback message associated with the semi-persistent scheduling physical downlink message.

Aspect 21: The method of aspect 20, further comprising: dropping the feedback message based at least in part on dropping the semi-persistent scheduling physical downlink message.

Aspect 22: The method of any of aspects 20 through 21, further comprising: transmitting the feedback message as a negative acknowledgement message based at least in part on dropping the semi-persistent scheduling physical downlink message.

Aspect 23: The method of any of aspects 13 through 22, wherein the control information is DCI associated with dynamic scheduling, the signaling is RRC signaling associated with semi-static scheduling, the uplink message is a PUCCH, a PUSCH, a SRS, or a PRACH, and the one or more downlink messages are one or more of a PDSCH, a physical downlink controller channel, or a CSI-RS.

Aspect 24: A method, at a network entity, comprising: outputting, at a first time, control information that schedules a UE to receive a downlink message that is associated with repetition across one or more full duplex slots; outputting signaling that schedules the UE to transmit one or more uplink messages across the one or more full duplex slots, wherein at least one uplink message of the one or more uplink messages overlaps in time with at least one repetition of the downlink message; and communicating, during each full duplex slot of the one or more full duplex slots, a repetition of the downlink message or an uplink message of the one or more uplink messages based at least in part on a respective priority associated with each repetition of the downlink message and each of the one or more uplink messages and based at least in part on whether at least one of the one or more uplink messages overlaps with a transmission timeline relative to the first time.

Aspect 25: The method of aspect 24, wherein the one or more full duplex slots includes a plurality of full duplex slots, the method further comprising: outputting, during each full duplex slot of the plurality of full duplex slots, the repetition of the downlink message based at least in part on the respective priority associated with each repetition of the downlink message being greater than the respective priority of each of the one or more uplink messages.

Aspect 26: The method of any of aspects 24 through 25, wherein the one or more full duplex slots includes a plurality of full duplex slots, the downlink message is associated with a first subset of repetitions across a first subset of full duplex slots of the plurality of full duplex slots, the downlink message is associated with a second subset of repetitions across a second subset of full duplex slots of the plurality of full duplex slots, and the second subset of full duplex slots are subsequent to the first subset of full duplex slots.

Aspect 27: The method of aspect 26, wherein the first subset of repetitions is associated with a first priority that is greater than the respective priority of the one or more uplink messages, the method further comprising: outputting, during the first subset of full duplex slots, the first subset of repetitions of the downlink message based at least in part on the first subset of repetitions being associated with the first priority.

Aspect 28: The method of any of aspects 26 through 27, further comprising: obtaining an uplink message of the one or more uplink messages based at least in part on the uplink message being scheduled for transmission during a full duplex slot of the second subset of full duplex slots and based at least in part on the uplink message being a random access message.

Aspect 29: The method of any of aspects 26 through 28, wherein the second subset of repetitions is associated with a first physical layer priority, the method further comprising: obtaining an uplink message of the one or more uplink messages based at least in part on the uplink message being scheduled for transmission during a full duplex slot of the second subset of full duplex slots and based at least in part on the uplink message being associated with a second physical layer priority that is greater than the first physical layer priority.

Aspect 30: The method of any of aspects 24 through 29, wherein the one or more full duplex slots includes a single full duplex slot scheduled with a downlink message via the control information and scheduled with an uplink message via the signaling, a first portion of the uplink message spans a first subset of symbols of the single full duplex slot that is within the transmission timeline, and a second portion of the uplink message spans a second subset of symbols of the single full duplex slot that is subsequent to the transmission timeline.

Aspect 31: The method of aspect 30, further comprising: obtaining, from the UE, an indication that the UE is configured with a cancellation capability to partially cancel messages scheduled for full duplex symbols; and obtaining the first portion of the uplink message based at least in part on the first portion of the uplink message spanning the first subset of symbols within the transmission timeline and based at least in part on obtaining the cancellation capability.

Aspect 32: The method of any of aspects 30 through 31, further comprising: obtaining the first portion of the uplink message based at least in part on the first portion of the uplink message spanning the first subset of symbols within the transmission timeline and based at least in part on the uplink message being a SRS.

Aspect 33: The method of any of aspects 24 through 32, wherein the control information is DCI associated with dynamic scheduling, the signaling is RRC signaling associated with semi-static scheduling, the downlink message is a PDSCH or a CSI-RS, and the one or more uplink messages are one or more of a PUCCH, a PUSCH, a SRS, or a PRACH.

Aspect 34: A method, at a network entity, comprising: outputting control information that schedules a UE to transmit an uplink message that is associated with repetition across one or more full duplex slots; outputting signaling that schedules the UE to receive one or more downlink messages across the one or more full duplex slots, wherein at least one of the one or more downlink messages overlaps in time with at least one repetition of the uplink message; and communicating, during each full duplex slot of the one or more full duplex slots, a repetition of the uplink message or a downlink message of the one or more downlink messages based at least in part on a respective priority associated with each repetition of the uplink message and each of the one or more downlink messages.

Aspect 35: The method of aspect 34, wherein the one or more full duplex slots includes a plurality of full duplex slots, the method further comprising: obtaining, during each full duplex slot of the plurality of full duplex slots, the repetition of the uplink message based at least in part on the respective priority associated with each repetition of the uplink message being greater than the respective priority of each of the one or more downlink messages.

Aspect 36: The method of any of aspects 34 through 35, wherein the one or more full duplex slots includes a plurality of full duplex slots, the uplink message is associated with a first subset of repetitions across a first subset of full duplex slots of the plurality of full duplex slots, the uplink message is associated with a second subset of repetitions across a second subset of full duplex slots of the plurality of full duplex slots, and the second subset of full duplex slots are subsequent to the first subset of full duplex slots.

Aspect 37: The method of aspect 36, wherein the first subset of repetitions is associated with a first priority that is greater than the respective priority of the one or more downlink messages, the method further comprising: obtaining, during the first subset of full duplex slots, the first subset of repetitions of the uplink message based at least in part on the first subset of repetitions being associated with the first priority.

Aspect 38: The method of any of aspects 36 through 37, further comprising: outputting a downlink message of the one or more downlink messages based at least in part on the downlink message being scheduled for transmission during a full duplex slot of the second subset of full duplex slots and based at least in part on the downlink message being a physical downlink control channel message.

Aspect 39: The method of any of aspects 36 through 38, wherein the second subset of repetitions is associated with a first physical layer priority, the method further comprising: outputting a downlink message of the one or more downlink messages based at least in part on the downlink message being scheduled for transmission during a full duplex slot of the second subset of full duplex slots and based at least in part on the downlink message being associated with a second physical layer priority that is greater than the first physical layer priority.

Aspect 40: The method of any of aspects 34 through 39, wherein a first full duplex slot of the one or more full duplex slots is scheduled with a physical uplink message and scheduled with a semi-persistent scheduling physical downlink message, the method further comprising: obtaining the physical uplink message based at least in part on a first priority associated with the physical uplink message being greater than a second priority associated with the semi-persistent scheduling physical downlink message.

Aspect 41: The method of aspect 40, wherein a second full duplex slot of the one or more full duplex slots is scheduled for the UE to transmit a feedback message associated with the semi-persistent scheduling physical downlink message.

Aspect 42: The method of aspect 41, further comprising: obtaining the feedback message as a negative acknowledgement message based at least in part on dropping the semi-persistent scheduling physical downlink message.

Aspect 43: The method of any of aspects 34 through 42, wherein the control information is DCI associated with dynamic scheduling, the signaling is RRC signaling associated with semi-static scheduling, the uplink message is a PUCCH, a PUSCH, a SRS, or a PRACH, and the one or more downlink messages are one or more of a PDSCH, a physical downlink controller channel, or a CSI-RS.

Aspect 44: A UE comprising one or more memories storing processor-executable code, and one or more processors coupled with the one or more memories and individually or collectively operable to execute the code to cause the UE to perform a method of any of aspects 1 through 12.

Aspect 45: A UE comprising at least one means for performing a method of any of aspects 1 through 12.

Aspect 46: A non-transitory computer-readable medium storing code the code comprising instructions executable by one or more processors to perform a method of any of aspects 1 through 12.

Aspect 47: A UE comprising one or more memories storing processor-executable code, and one or more processors coupled with the one or more memories and individually or collectively operable to execute the code to cause the UE to perform a method of any of aspects 13 through 23.

Aspect 48: A UE comprising at least one means for performing a method of any of aspects 13 through 23.

Aspect 49: A non-transitory computer-readable medium storing code the code comprising instructions executable by one or more processors to perform a method of any of aspects 13 through 23.

Aspect 50: A network entity comprising one or more memories storing processor-executable code, and one or more processors coupled with the one or more memories and individually or collectively operable to execute the code to cause the network entity to perform a method of any of aspects 24 through 33.

Aspect 51: A network entity comprising at least one means for performing a method of any of aspects 24 through 33.

Aspect 52: A non-transitory computer-readable medium storing code the code comprising instructions executable by one or more processors to perform a method of any of aspects 24 through 33.

Aspect 53: A network entity comprising one or more memories storing processor-executable code, and one or more processors coupled with the one or more memories and individually or collectively operable to execute the code to cause the network entity to perform a method of any of aspects 34 through 43.

Aspect 54: A network entity comprising at least one means for performing a method of any of aspects 34 through 43.

Aspect 55: A non-transitory computer-readable medium storing code the code comprising instructions executable by one or more processors to perform a method of any of aspects 34 through 43.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, at a first time, control information that schedules the UE to receive a downlink message that is associated with repetition across one or more full duplex slots;
receive signaling that schedules the UE to transmit one or more uplink messages across the one or more full duplex slots, wherein at least one of the one or more uplink messages overlaps in time with at least one repetition of the downlink message; and
communicate, during each full duplex slot of the one or more full duplex slots, a repetition of the downlink message or an uplink message of the one or more uplink messages based at least in part on a respective priority associated with each repetition of the downlink message and each of the one or more uplink messages and based at least in part on whether at least one of the one or more uplink messages overlaps with a transmission timeline relative to the first time.

2. The UE of claim 1, wherein the one or more full duplex slots includes a plurality of full duplex slots, and the one or more processors are individually or collectively further operable to execute the code to cause the UE to:
receive, during each full duplex slot of the plurality of full duplex slots, the repetition of the downlink message based at least in part on the respective priority associated with each repetition of the downlink message being greater than the respective priority of each of the one or more uplink messages; and
dropping, during each full duplex slot of the plurality of full duplex slots, the one or more uplink messages base at least in part on the respective priority associated with each repetition of the downlink message being greater than the respective priority of each of the one or more uplink messages.

3. The UE of claim 1, wherein:
the one or more full duplex slots includes a plurality of full duplex slots;
the downlink message is associated with a first subset of repetitions across a first subset of full duplex slots of the plurality of full duplex slots;
the downlink message is associated with a second subset of repetitions across a second subset of full duplex slots of the plurality of full duplex slots; and
the second subset of full duplex slots are subsequent to the first subset of full duplex slots.

4. The UE of claim 3, wherein the first subset of repetitions is associated with a first priority that is greater than the respective priority of the one or more uplink messages, and the one or more processors are individually or collectively further operable to execute the code to cause the UE to:
receive, during the first subset of full duplex slots, the first subset of repetitions of the downlink message based at least in part on the first subset of repetitions being associated with the first priority.

5. The UE of claim 3, wherein the one or more processors are individually or collectively further operable to execute the code to cause the UE to:
transmit an uplink message of the one or more uplink messages based at least in part on the uplink message being scheduled for transmission during a full duplex slot of the second subset of full duplex slots and based at least in part on the uplink message being a random access message.

6. The UE of claim 3, wherein the second subset of repetitions is associated with a first physical layer priority, and the one or more processors are individually or collectively further operable to execute the code to cause the UE to:
transmit an uplink message of the one or more uplink messages based at least in part on the uplink message being scheduled for transmission during a full duplex slot of the second subset of full duplex slots and based at least in part on the uplink message being associated with a second physical layer priority that is greater than the first physical layer priority.

7. The UE of claim 1, wherein:
the one or more full duplex slots includes a single full duplex slot scheduled with a downlink message via the control information and scheduled with an uplink message via the signaling;
a first portion of the uplink message spans a first subset of symbols of the single full duplex slot that is within the transmission timeline; and
a second portion of the uplink message spans a second subset of symbols of the single full duplex slot that is subsequent to the transmission timeline.

8. The UE of claim 7, wherein the UE is configured with a cancellation capability to partially cancel messages scheduled for full duplex symbols, and the one or more processors are individually or collectively further operable to execute the code to cause the UE to:
transmit the first portion of the uplink message and the second portion of the uplink message based at least in part on refraining from indicating the cancellation capability to a network entity.

9. The UE of claim 7, wherein the one or more processors are individually or collectively further operable to execute the code to cause the UE to:
transmit, to a network entity, an indication that the UE is configured with a cancellation capability to partially cancel messages scheduled for full duplex symbols; and
transmit the first portion of the uplink message based at least in part on the first portion of the uplink message spanning the first subset of symbols within the transmission timeline and based at least in part on transmitting the cancellation capability.

10. The UE of claim 7, wherein the UE is not configured with a cancellation capability to partially cancel messages scheduled for full duplex symbols, and the one or more processors are individually or collectively further operable to execute the code to cause the UE to:
transmit the first portion of the uplink message and the second portion of the uplink message based at least in part on not being configured with the cancellation capability.

11. The UE of claim 7, wherein the one or more processors are individually or collectively further operable to execute the code to cause the UE to:
transmit the first portion of the uplink message based at least in part on the first portion of the uplink message spanning the first subset of symbols within the transmission timeline and based at least in part on the uplink message being a sounding reference signal.

12. The UE of claim 1, wherein the control information is downlink control information associated with dynamic scheduling, the signaling is radio resource control signaling associated with semi-static scheduling, the downlink message is a physical downlink shared channel or a channel state information reference signal, and the one or more uplink messages are one or more of a physical uplink control channel, a physical uplink shared channel, a sounding reference signal, or a physical random access channel.

13. A user equipment (UE), comprising:
one or more memories storing processor-executable code; and
one or more processors coupled with the one or more memories and individually or collectively operable to execute the code to cause the UE to:
receive control information that schedules the UE to transmit an uplink message that is associated with repetition across one or more full duplex slots;
receive signaling that schedules the UE to receive one or more downlink messages across the one or more full duplex slots, wherein at least one of the one or more downlink messages overlaps in time with at least one repetition of the uplink message; and
communicate, during each full duplex slot of the one or more full duplex slots, a repetition of the uplink message or a downlink message of the one or more downlink messages based at least in part on a respective priority associated with each repetition of the uplink message and each of the one or more downlink messages.

14. The UE of claim 13, wherein the one or more full duplex slots includes a plurality of full duplex slots, and the one or more processors are individually or collectively further operable to execute the code to cause the UE to:
transmit, during each full duplex slot of the plurality of full duplex slots, the repetition of the uplink message based at least in part on the respective priority associated with each repetition of the uplink message being greater than the respective priority of each of the one or more downlink messages; and
dropping, during each full duplex slot of the plurality of full duplex slots, the one or more downlink messages base at least in part on the respective priority associated with each repetition of the uplink message being greater than the respective priority of each of the one or more downlink messages.

15. The UE of claim 13, wherein:
the one or more full duplex slots includes a plurality of full duplex slots;
the uplink message is associated with a first subset of repetitions across a first subset of full duplex slots of the plurality of full duplex slots;
the uplink message is associated with a second subset of repetitions across a second subset of full duplex slots of the plurality of full duplex slots; and
the second subset of full duplex slots are subsequent to the first subset of full duplex slots.

16. The UE of claim 15, wherein the first subset of repetitions is associated with a first priority that is greater than the respective priority of the one or more downlink messages, and the one or more processors are individually or collectively further operable to execute the code to cause the UE to:
transmit, during the first subset of full duplex slots, the first subset of repetitions of the uplink message based at least in part on the first subset of repetitions being associated with the first priority.

17. The UE of claim 15, wherein the one or more processors are individually or collectively further operable to execute the code to cause the UE to:
receive a downlink message of the one or more downlink messages based at least in part on the downlink message being scheduled for transmission during a full duplex slot of the second subset of full duplex slots and based at least in part on the downlink message being a physical downlink control channel message.

18. The UE of claim 15, wherein the second subset of repetitions is associated with a first physical layer priority, and the one or more processors are individually or collectively further operable to execute the code to cause the UE to:
receive a downlink message of the one or more downlink messages based at least in part on the downlink message being scheduled for transmission during a full duplex slot of the second subset of full duplex slots and based at least in part on the downlink message being associated with a second physical layer priority that is greater than the first physical layer priority.

19. The UE of claim 13, wherein a first full duplex slot of the one or more full duplex slots is scheduled with a physical uplink message and scheduled with a semi-persistent scheduling physical downlink message, and the one or more processors are individually or collectively further operable to execute the code to cause the UE to:
transmit the physical uplink message based at least in part on a first priority associated with the physical uplink message being greater than a second priority associated with the semi-persistent scheduling physical downlink message.

20. The UE of claim 19, wherein a second full duplex slot of the one or more full duplex slots is scheduled for the UE to transmit a feedback message associated with the semi-persistent scheduling physical downlink message.

21. The UE of claim 20, wherein the one or more processors are individually or collectively further operable to execute the code to cause the UE to:
drop the feedback message based at least in part on dropping the semi-persistent scheduling physical downlink message.

22. The UE of claim 20, wherein the one or more processors are individually or collectively further operable to execute the code to cause the UE to:
transmit the feedback message as a negative acknowledgement message based at least in part on dropping the semi-persistent scheduling physical downlink message.

23. The UE of claim 13, wherein the control information is downlink control information associated with dynamic scheduling, the signaling is radio resource control signaling associated with semi-static scheduling, the uplink message is a physical uplink control channel, a physical uplink shared channel, a sounding reference signal, or a physical random access channel, and the one or more downlink messages are one or more of a physical downlink shared channel, a physical downlink controller channel, or a channel state information reference signal.

24. A network entity, comprising:
one or more memories storing processor-executable code; and
one or more processors coupled with the one or more memories and individually or collectively operable to execute the code to cause the network entity to:
output, at a first time, control information that schedules a user equipment (UE) to receive a downlink message that is associated with repetition across one or more full duplex slots;
output signaling that schedules the UE to transmit one or more uplink messages across the one or more full duplex slots, wherein at least one uplink message of the one or more uplink messages overlaps in time with at least one repetition of the downlink message; and
communicate, during each full duplex slot of the one or more full duplex slots, a repetition of the downlink message or an uplink message of the one or more uplink messages based at least in part on a respective priority associated with each repetition of the downlink message and each of the one or more uplink messages and based at least in part on whether at least one of the one or more uplink messages overlaps with a transmission timeline relative to the first time.

25. The network entity of claim 24, wherein the one or more full duplex slots includes a plurality of full duplex slots, and the one or more processors are individually or collectively further operable to execute the code to cause the network entity to:
output, during each full duplex slot of the plurality of full duplex slots, the repetition of the downlink message based at least in part on the respective priority associated with each repetition of the downlink message being greater than the respective priority of each of the one or more uplink messages.

26. The network entity of claim 24, wherein:
the one or more full duplex slots includes a plurality of full duplex slots;
the downlink message is associated with a first subset of repetitions across a first subset of full duplex slots of the plurality of full duplex slots;
the downlink message is associated with a second subset of repetitions across a second subset of full duplex slots of the plurality of full duplex slots; and
the second subset of full duplex slots are subsequent to the first subset of full duplex slots.

27. The network entity of claim 26, wherein the first subset of repetitions is associated with a first priority that is greater than the respective priority of the one or more uplink messages, and the one or more processors are individually or collectively further operable to execute the code to cause the network entity to:
output, during the first subset of full duplex slots, the first subset of repetitions of the downlink message based at least in part on the first subset of repetitions being associated with the first priority.

28. The network entity of claim 26, wherein the one or more processors are individually or collectively further operable to execute the code to cause the network entity to:
obtain an uplink message of the one or more uplink messages based at least in part on the uplink message being scheduled for transmission during a full duplex slot of the second subset of full duplex slots and based at least in part on the uplink message being a random access message.

29. A network entity, comprising:
one or more memories storing processor-executable code; and
one or more processors coupled with the one or more memories and individually or collectively operable to execute the code to cause the network entity to:
output control information that schedules a user equipment (UE) to transmit an uplink message that is associated with repetition across one or more full duplex slots;
output signaling that schedules the UE to receive one or more downlink messages across the one or more full duplex slots, wherein at least one of the one or more downlink messages overlaps in time with at least one repetition of the uplink message; and
communicate, during each full duplex slot of the one or more full duplex slots, a repetition of the uplink message or a downlink message of the one or more downlink messages based at least in part on a respective priority associated with each repetition of the uplink message and each of the one or more downlink messages.

30. The network entity of claim 29, wherein the one or more full duplex slots includes a plurality of full duplex slots, and the one or more processors are individually or collectively further operable to execute the code to cause the network entity to:
obtain, during each full duplex slot of the plurality of full duplex slots, the repetition of the uplink message based at least in part on the respective priority associated with each repetition of the uplink message being greater than the respective priority of each of the one or more downlink messages.
